(19) United States
(12) Patent Application Publication
(10) Pub. No.: US 2010/0021218 A1
(43) Pub. Date: Jan. 28, 2010

(54) RECORDING MEDIUM CARRYING DEVICE AND IMAGE FORMING DEVICE

(75) Inventors: Keisuke Watanabe, Nagoya (JP); Yosuke Aoi, Nagoya (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya (JP)

(21) Appl. No.: 12/492,979

(22) Filed: Jun. 26, 2009

(30) Foreign Application Priority Data
Jul. 22, 2008 (JP) 2008188881
Sep. 9, 2008 (JP) 2008231096
Apr. 30, 2009 (JP) 2006111080

(51) Int. Cl. G03G 15/00; B65H 5/02

(52) U.S. Cl. 399/361; 271/264

(57) ABSTRACT

There is provided a recoding medium carrying device, comprising: a carrying unit configured to carry a recording medium in a carrying direction which is substantially perpendicular to a width direction of the recording medium; a guide member that is provided on an upstream side of the carrying unit in the carrying direction and has a guide surface located to face a surface of the recording medium to guide the recording medium along the guide surface; and a resistance member that is located on the guide member and applies stronger resistance to a center portion of the recording medium in the width direction in comparison with both ends of the recording medium in the width direction.

### CROSS-REFERENCE TO RELATED APPLICATION

This application claims priority under 35 U.S.C. §119 from Japanese Patent Applications No. 2008-188881, filed on Jul. 22, 2008, No. 2008-231096, filed on Sep. 9, 2008, and No. 2009-111080, filed on Apr. 30, 2009. The entire subject matter of the applications is incorporated herein by reference.

### BACKGROUND

1. Technical Field

Aspects of the present invention relate to an image forming device and a recording medium carrying device provided in the image forming device for carrying a recording medium.

2. Related Art

Color image forming devices having a carrying belt which carries a recording medium to which a tone image is transferred, a plurality of rotation rollers provided in the inner portion of the carrying belt to move the carrying belt in a circulating motion, and a plurality of image formation units for forming toner mages are widely used. An example of such an image forming device is disclosed in Japanese Patent Provisional Publication No. HEI 5-270686 (hereafter, referred to as JP HEI 5-270686A).

The image forming device disclosed in JP HEI 5-270686A is provided with an absorbing roller on the upstream side of the carrying belt in a carrying direction in which a recording medium is carried. The absorbing roller is positioned to face a rotation roller located at the upstream end position in the carrying direction while sandwiching the carrying belt between the absorbing roller and the rotation roller. The recording medium being carried to the carrying belt is absorbed to the carrying belt by being sandwiched between the absorbing roller and the rotation roller on the upstream side of the carrying belt. By this structure, it becomes possible to enhance the degree of adhesion between the recording medium and the carrying belt.

### SUMMARY

However, there is a possibility that a phenomenon which is so-called “preceding of a center portion” is caused during carrying of a recording medium. More specifically, the “preceding of a center portion” means a phenomenon where a center portion of a sheet of paper defined in a width direction which is perpendicular to the carrying direction of the recording medium precedes with respect to both end portions of the sheet of paper defined in the width direction.

Assuming a case where a plurality of recording mediums (a stack of recording mediums) are placed under a high temperature and humidity condition, in this case only a peripheral part of the stack of recording mediums is exposed to air, and therefore both end portions of the recording mediums absorb water from the air while the center portion of each recording medium remains in a dry condition. In other words, the degree of wetness of each recording medium varies in the width direction of the recording medium. Because the recording medium is in the state where the center is in a dry state and the both end portions are in a wet state, the center portion is rigid while the both end portions are soft.

If the preceding of the center portion occurs on the recording medium before being supplied to a carrying unit, the center portion of the recording medium contacts the carrying unit earlier than the both ends of the recording medium around the leading edge portion of the recording medium. In this case, a force pointing to from each end in the width direction to the center portion is produced.

If the recording medium is in the condition where the center portion is rigid while the both ends are soft, a force pointing from each end to the center portion and an elastic force in the center portion repel with respect to each other, and thereby creases may be caused on the recording medium. If a toner image is transferred to the recording medium in the state where the creases have been produced on the recording medium, a transfer error of a toner image is caused on a region of the creases. In addition, if the recording medium has creases, faulty carrying of the recording medium may be caused.

Therefore, it is required to prevent occurrence of the preceding of the center portion.

In the image forming device disclosed in JP HEI 5-270686A, the absorbing roller is formed to extend in the width direction, and both ends of the absorbing roller in the width direction are supported by a main body of the image forming device. That is, in the absorbing roller, the both ends have a higher degree of rigidity than that of the center portion. Therefore, when the recording medium is sandwiched between the absorbing roller and the rotation roller, the recording medium is sandwiched more strongly at the center portion than the both ends of the recording medium. Therefore, in the image forming device disclosed in JP HEI 5-270686A, the preceding of the center portion can not be prevented, and what is even worse is that the preceding of the center portion may be promoted.

Aspects of the present invention are advantageous in that at least one of a recording medium carrying device and an image forming device capable of preventing occurrence of preceding of a center portion of a recording medium is provided.

According to an aspect of the invention, there is provided a recoding medium carrying device, comprising: a carrying unit configured to carry a recording medium in a carrying direction which is substantially perpendicular to a width direction of the recording medium; a guide member that is provided on an upstream side of the carrying unit in the carrying direction and has a guide surface located to face a surface of the recording medium to guide the recording medium along the guide surface; and a resistance member that is located on the guide member and applies stronger resistance to a center portion of the recording medium in the width direction in comparison with both ends of the recording medium in the width direction.

Such a configuration makes it possible to prevent occurrence of a phenomenon that a center portion of the recording medium is carried earlier than both ends of the recording medium in the width direction. Therefore, it becomes possible to prevent occurrence of the preceding of the center portion of the recording medium, and thereby to smoothly carry the recording medium to the carrying unit.

According to another aspect of the invention, there is provided an image forming device, comprising: the above described recording medium carrying device; and an image formation unit configured to form an image on a recording medium being carried by the recording medium carrying device.

Such a configuration makes it possible to prevent occurrence of a phenomenon that a center portion of the recording medium is carried earlier than both ends of the recording medium in the width direction. Therefore, it becomes possible to prevent occurrence of the preceding of the center portion of the recording medium, and thereby to smoothly carry the recording medium to the carrying unit.

According to another aspect of the invention, there is provided an image forming device, comprising: a main body; a photosensitive unit having a photosensitive body on which an electrostatic latent image is formed, the photosensitive unit being formed to detachably attachable to the main body; a carrying unit provided in the main body to carry a recording medium in a carrying direction; a pressing member which is provided in the photosensitive unit and is located on an upstream side in the carrying direction with respect to the carrying unit, the pressing member being provided to press only a center portion of the recording medium defined in a width direction which is substantially perpendicular to the carrying direction; and a first guide member which is provided in the main body and is located on the upstream side in the carrying direction with respect to the carrying unit, the first guide member guiding the recording medium toward the carrying unit.

Such a configuration makes it possible to prevent occurrence of a phenomenon that a center portion of the recording medium is carried earlier than both ends of the recording medium in the width direction. Therefore, it becomes possible to prevent occurrence of the preceding of the center portion of the recording medium, and thereby to smoothly carry the recording medium to the carrying unit.

It is noted that various connections are set forth between elements in the following description. It is noted that these connections in general and unless specified otherwise, may be direct or indirect and that this specification is not intended to be limiting in this respect. Aspects of the invention may be implemented in computer software as programs storable on computer-readable media including but not limited to RAMs, ROMs, flash memory, EEPROMs, CD-media, DVD-media, temporary storage, hard disk drives, floppy drives, permanent storage, and the like.

### BRIEF DESCRIPTION OF THE ACCOMPANYING DRAWINGS

FIG. 1 is a side cross section of a printer according to a first embodiment.

FIG. 2 is a perspective view of a paper carrying unit viewed from a rear left side.

FIG. 3 is an enlarged side cross section illustrating a main part of the paper carrying unit.

FIG. 4 is an explanatory illustration for explaining shift of image transfer caused by preceding of a center portion of a sheet of paper.

FIG. 5A is a plan view illustrating a main part of a paper carrying unit according to a first variation, and FIG. 5B is a cross section viewed along a line A-A in FIG. 5A.

FIGS. 6A and 6B illustrate a state where a pressing member shown in FIGS. 5A and 5B is in a pressing-released state.

FIG. 7 is a plan view of a main part of a paper carrying unit according to a second variation in a state where a pressing member is in a pressing state.

FIG. 8 illustrates a state where the pressing member shown in FIG. 7 is in the pressing-released state.

FIG. 9 is a plan view of a main part of a paper carrying unit according to a third variation in a state where a pressing member is in a pressing state.

FIG. 10 illustrates a state where the pressing member shown in FIG. 9 is in the pressing-released state.

FIG. 11 is a side cross section of a printer according to a second embodiment.

FIG. 12 is a perspective view of the printer according to the second embodiment viewed from a front right side.

FIG. 13 is a perspective view of a paper carrying unit illustrating a portion around a front wall of a process frame when viewed from a rear left side.

FIG. 14 is an enlarged side cross section illustrating a main part of the paper carrying unit shown in FIG. 13.

### DETAILED DESCRIPTION

Hereafter, embodiments according to the invention will be described with reference to the accompanying drawings.

### First Embodiment

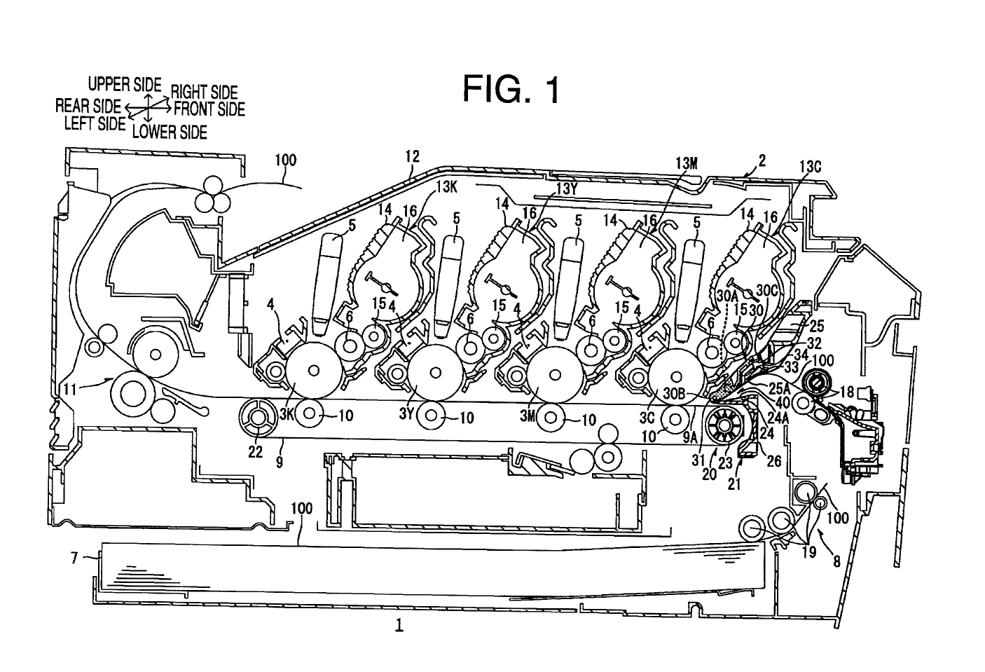

FIG. 1 is a side cross section of a printer 1 (an image forming device) according to a first embodiment. In the following, directions are defined for explanations of the configuration of the image forming device with reference to directions of arrows show in relevant drawings. More specifically, the left and right direction equal to the width direction, and the horizontal direction includes the width direction and the back-and-forth direction.

The printer 1 is a color printer. As shown in FIG. 1, in a body casing 2 of the printer 1, four photosensitive drums 3 are provided to be rotatable, and are arranged in parallel with each other along the back and forth direction. In the following, in accordance with colors of toner (black, cyan, magenta and yellow), the four photosensitive drums 3 are defined as a photosensitive drum 3K (for black color), a photosensitive drum 3C (for cyan color), a photosensitive drum 3M (for magenta color), and a photosensitive drum 3Y (for yellow color). In the following, frequently the four photosensitive drums 3K, 3Cm 3M and 3Y are generically called the photosensitive drum 3 for the sake of simplicity.

After a surface of the photosensitive drum 3 is uniformly charged by a scorotron type charger 4, the surface of the photosensitive drum 3 is exposed by an LED (not shown) provided on an LED unit 5. By this structure, an electrostatic latent image based on image data is formed on the photosensitive drum 3. The electrostatic latent image is visualized by toner (developer) held on a development roller 6 corresponding to the photosensitive drum 3. That is, a toner image is formed on the surface of the photosensitive drum 3.

Sheets of paper 100 which are examples of a sheet-like recording medium are accommodated in a paper supply cassette 7 provided at the bottom of the body casing 2 such that the sheets of paper 100 are stacked in the vertical direction. The top of the stacked sheets of paper 100 is fed and carried by rollers provided in a paper supply part 8 around the front end portion of the paper supply cassette 7 to move upward and to turn from the front side toward the rear side, and is carried by a carrying belt 9 serving as a carrying unit.

In this case, the width direction (shorter side direction) of the sheet of paper 100 and the width direction of the printer 1 are equal to each other. In the body casing 2, the sheet of paper 100 is carried in a direction perpendicular to the width direction of the sheet of paper while being moved in the back-and-forth and upward from the paper supply cassette 7 to an output tray 12. Further, the rollers provided around the paper supply part 8 include a pair of registration rollers 18. The registration rollers 18 carry the sheet of paper supplied from the paper supply cassette 7 to the carrying belt 9 at predetermined timing. It should be noted that the recording medium includes an OHP sheet as well as a sheet of paper.

As shown in FIG. 1, the carrying belt 9 is provided between the photosensitive drums 3K, 3C, 3M and 3Y and transfer rollers 10. The toner images respectively formed on the photosensitive drums 3K, 3C, 3M and 3Y are transferred to the sheet of paper 10 by a transfer bias applied to the transfer roller 10 so that the toner images are overlaid appropriately.

The sheet of paper 100 to which the four color toner images have been transferred is carried by the carrying belt 9 to a fixing unit 11 provided on the rear side. Then, the toner image transferred on the sheet of paper 100 is fixed by the fixing unit 11 by heat. Thereafter, the sheet of paper 100 is moved upward while altering the moving direction from the rear side toward the front side, and is ejected to the output tray 12 provided on the upper side of the body casing 2.

As described above, the sheet of paper 100 is carried from the paper supply cassette 7 to the output tray 12 while being moved in the vertical direction and/or in the back-and-forth direction.

The printer 1 includes four process cartridges 13 functioning as image formation units. In the following, in accordance with colors of toner (black, cyan, magenta and yellow), the four process cartridges 13 are defined as a process cartridge 13K (for black color), a process cartridge 13C (for cyan color), a process cartridge 13M (for magenta color), and a process cartridge 13Y (for yellow color). In the following, frequently the four process cartridges 13K, 13C, 13M and 13Y are generically called the process cartridge 13 for the sake of simplicity.

Each process cartridge 13 is detachably attached in the body casing 2. The process cartridges 13K, 13C, 13M and 13Y are arranged in parallel with each other along the back-and-forth direction in the body casing 2. An upper wall (i.e., the output tray 12) of the body casing 2 is formed to be movable so that the internal structure is exposed toward the outside and that the process cartridge 13 can be detachably attached to the body casing from the upper side.

In a casing of each process cartridge 13, the photosensitive drum 3, the scorotron type charger 4, the development roller 6 and a supply roller 15 and a toner hopper 16 are provided. A center axis of each of the photosensitive drum 3, the development roller 6 and the supply roller 15 extends in the width direction. In the process cartridge 13, the toner stored in the toner hopper 16 is supplied to the development roller 6 by the supply roller 15, and the toner is held on the development roller 6 as described above.

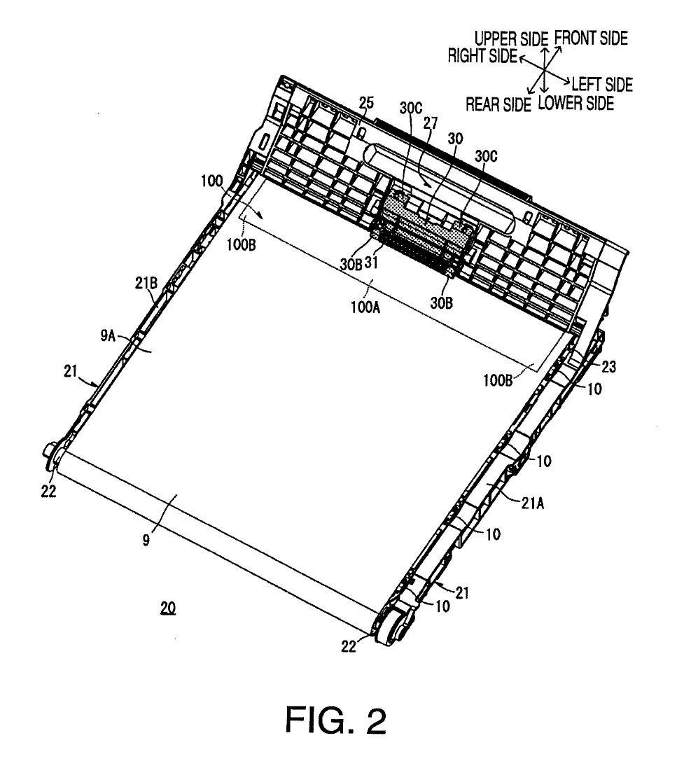

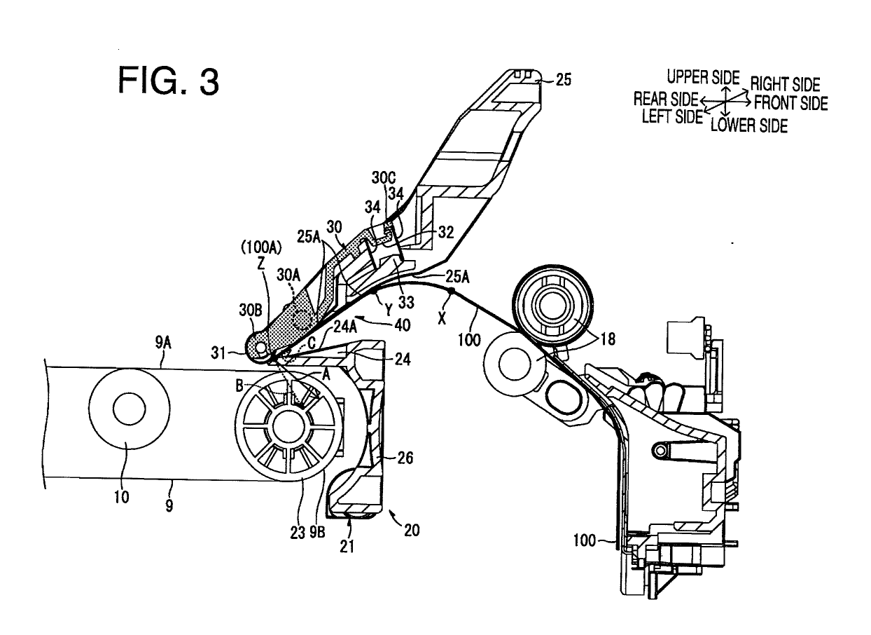

The printer 1 is provided with a paper carrying unit 20 serving as a paper carrying device. FIG. 2 is a perspective view of a paper carrying unit 20 viewed from a rear left side. FIG. 3 is an enlarged side cross section illustrating a main part of the paper carrying unit 20. In the body casing 2, the paper carrying unit 20 is located on an upper side of the paper supply cassette 7 and on a lower side of each process cartridge 13. The paper carrying unit 20 has a frame 21. The paper carrying unit 20 is configured such that the carrying belt 9 and all the transfer rollers 10 are supported by the frame 21. The paper carrying unit 20 further includes a drive roller 22 and a driven roller 23.

As shown in FIG. 2, the frame 21 has a pair of side walls 21A and 21B positioned at both right and left ends of the carrying belt 9, and members connecting the side walls 21A and 21B (not shown) so that the frame 21 has a thin rectangular frame when viewed as a plan view. The drive roller 22 and the driven roller 23 are arranged along the back-and-forth direction to have a certain interval. That is, a center axis of each of the drive roller 22 and the driven roller 23 extends in the width direction (perpendicular to the paper carrying direction extending in the back-and-forth direction) (see FIG. 1). More specifically, the drive roller 22 is supported at the rear end of the frame 21 to bridge the rear ends of the side walls 21A and 21B, and the driven roller 23 is supported at the front end of the frame 21 to bridge the front ends of the side walls 21A and 21B.

The carrying belt 9 has the width larger than the sheet of paper 100 (see a dotted line in FIG. 2). The carrying belt 9 is an endless belt made of resin such as polycarbonate. The carrying belt 9 is wound around the drive roller 22 and the driven roller 23 to have a certain tension. That is, the carrying belt 9 is supported on the frame 21 via the drive roller 22 and the driven roller 23. In this state, at least the upper surface of the carrying belt 9 (i.e., an upper part 9A which is an example of a carrying surface) is kept to be horizontal (see FIGS. 1 and 3). Each of the side walls 21A and 21B is formed to protrude in the width direction relative to the side edge of the carrying belt 9 throughout the entire range between the drive roller 22 and the driven roller 23 in the back-and-forth direction.

As described above, four transfer rollers 10 are provided for respective photosensitive drums 3. Each of the transfer rollers 10 is supported on the frame 21 to bridge the side walls 21A and 21B. As shown in FIG. 1, the transfer rollers 10 are arranged along the back-and-forth direction. Each of the transfer rollers 10 is provided in the inner portion of the carrying belt 9 wound around the drive roller 22 and the driven roller 23 to face the corresponding photosensitive drum 3 from the lower side via the upper part of the carrying belt 9.

When the image formation is performed, the drive roller 22 is rotated while being applied a driving force from a motor (not shown) provided in the body casing 2. Accordingly, the carrying belt 9 moves to rotate in the counterclockwise direction when viewed from the left side (see FIG. 1), and the driven roller 23 is driven to rotate. Consequently, the upper part 9A of the carrying belt 9 moves from the front side toward the rear side in the substantially horizontal direction.

When the sheet of paper 100 which has been carried to the carrying belt 9 from the paper supplied cassette 7 is placed on the upper part 9A of the carrying belt 9, the sheet of paper 9 is carried from the front side toward the rear side in the direction perpendicular to the width direction (i.e., the direction orthogonal to the paper face of FIG. 1). Along the carrying path of the sheet of paper 100, the sheet of paper passes a contact position (a transfer position) at which the photosensitive drum 3 contacts the upper part 9A of the carrying belt 9. At this moment, the toner images of the photosensitive drums 3 are transferred sequentially to the sheet of paper 100 to be overlaid with respect to each other. Then, the sheet of paper 100 on which the toner images have been transferred is carried further toward the rear side, and is supplied to the fixing unit 11.

As shown in FIG. 3, the paper carrying unit 20 includes a guide unit having a first guide member 24 and a second guide member 25 on the upstream side (front side) with respect to the carrying belt 9. That is, the guide unit is provided on the frame 21.

The first guide member 24 is a plate-like member having a longer side extending in the width direction (perpendicular to the carrying direction of the sheet of paper 100), and has the width larger than the width of the carrying belt 9. Although not shown in the drawings, the first guide member 24 is supported on the frame 21 by being bridged between the front ends of the side walls 21A and 21B of the frame 21. In this state, the first guide member 24 faces a part of the carrying belt 9 where the carrying belt 9 corresponds to the top of the driven roller 23, from the upper side to have a predetermined interval with respect to the carrying belt 9. That is, the first guide member 24 does not contact the carrying belt 9. The upper surface of the first guide member 24 is formed to tilt in the rear and downward direction. This upper surface of the first guide member 24 is defined as a first guide surface 24A. The first guide surface 24A approaches the upper part 9A of the carrying belt 9 from the upper side, from the front side toward the rear side (i.e., toward the downstream side).

A guard 26 is integrally formed with the frame 21 to bridge the front ends of the side walls 21A and 21B. The guard 26 is formed to extend downward to face a curved part 9B of the carrying belt 9 curving along the outer surface of the driven roller 23 at the front end of the carrying belt 9, and to form a predetermined interval with respect to the curved part 9B. With this structure, the guard 26 protects the curved part 9B from the front side. The first guide member 24 is integrally formed with the upper end of the guard 26.

The second guide member 25 is a plate-like member having a longer side extending in the width direction. As shown in FIG. 2, the second guide member 25 is provided at the upper portion with respect to the first guide member 24 to bridge the front ends of the right side wall 21A and the left side wall 21B and not to contact the carrying belt 9. That is, the second guide member 25 is provided on the frame 21.

As shown in FIG. 3, the second guide member 25 faces the first guide member 24 from the upper side to have a predetermined interval with respect to the first guide member 24. Similarly to the first guide member 24, the second guide member 25 entirely tilts to the downward and rear side. More specifically, the tilting angle of the second guide member 25 with respect to the horizontal surface is larger than the tilting angle of the first guide member 24 with respect to the horizontal surface.

Approximately lower half part of the second guide member 25 slanting as described above faces the first guide surface 24A from the upper side. The surface of the second guide member 25 facing the first guide surface 24A is defined as a second guide surface 25A. The substantial part of the second guide surface 25A is formed to be a flat surface tilting in the downward and rear direction to approach the first guide surface 24A from the front side toward the rear side, and the front end part of the second guide surface 25A is formed to recess smoothly toward the upper side.

Hereafter, frequently the first guide surface 24A and the second surface 25A are generally called a guide surface. In this case, the first guide surface 24A is called one guide surface, and the second guide surface 25A is called the other guide surface. The sheet of paper 100 is carried through space 40 formed between the first guide surface 24A and the second guide surface 25A, and in this case the first guide surface 24A faces the lower face of the sheet of paper 100 and the second guide surface 25A faces the upper face of the sheet of paper 100. It should be noted that the upper and lower faces of the sheet of paper 100 are parallel with the paper carrying direction and the width direction. Frequently, the lower face of the sheet of paper 100 is called one face of the sheet of paper and the upper face of the sheet of paper is called the other face of the sheet of paper 100.

When viewed from the left side, the space 40 sandwiched between the first guide surface 24A and the second guide surface 25A has a triangular shape becoming thinner toward the rear side. In other words, the interval between the first guide surface 24A and the second guide surface 25A becomes wider at a point closer to the upstream side along the paper carrying direction. The space 40 is wider than the carrying belt 9 in the width direction when viewed as a plan view. The rear end of the space 40 faces the upper part 9A of the carrying belt 9 from the front and upper side. The front end of the space 40 is opened. The pair of registration rollers 18 are located to face the opened part of the space 40 in the state where the registration rollers 18 face with each other. The registration rollers 18 are supported by the body casing 2 (i.e., the front wall of the body casing 1 shown in FIG. 1) to be rotatable.

As shown in FIG. 2, in a central portion of the upper edge of the upper surface of the second guide member 25, a long hole 27 extending in the width direction is formed. A user is able to attach the paper carrying unit 20 to or detach the paper carrying unit 20 from the body casing 2 by gripping a part of the paper carrying unit 20 through the long hole 27. Under the long hole 27, a support member 30 supported by the second guide member 25 and a pressing member 31 supported by the support member 30 are provided. The pressing member 31 functions as a resistance member. Since as described above the second guide member 25 is provided on the frame 21, the pressing member 31 is provided on the frame 21 via the support member 30 and the second guide member 25.

The support member 30 has the longer side extending in the width direction, and has a rectangular shape when viewed as a plan view. The support member 30 is configured to have a size which can be placed within a region under the long hole 27 on the upper surface of the second guide member 25 (see FIGS. 1-3, 5 and 10). The support member 30 is rotatably attached to the second guide member 25 in the state where support member 25 tilts in the downward and rear direction along the surface of the second guide member 25. As shown in FIG. 3, a rotation center 30A of the support member 30 is at a position shifted downward from a center of the support member 30 in the vertical direction when viewed from the left side, and the rotation axis of the support member 30 extends in the width direction while passing through the rotation center 30A. The lower end of the support member 30 is defined as an end 30B, and the upper end of the support member 30 is defined as an end 30C. The rotation center 30A is positioned to be sandwiched by the ends 30B and 30C both in the vertical direction and in the left and right direction. When the support member 30 rotates about the rotation center 30A, the ends 30B and 30C move up and down. More specifically, when the end 30B moves upward, the other end 30C moves downward, and when the end 30B moves downward, the other end 30C moves upward.

On a lower surface of the end 30C of the support member 30, a boss 32 is integrally formed with the support member 30 to protrude downward. On a part of the second guide member 25 facing the boss 32 from the lower side, a boss 33 is integrally formed with the second guide member 25 to protrude upward. Between the boss 32 and boss 33, a spring 34 serving as a biasing member is inserted. By this structure, the end 30C at which the boss 32 is formed is pressed toward the upper side by the spring 34 producing an elastic force to extend upward. Accordingly, the support member 30 is pressed entirely to rotate in the counterclockwise direction when viewed from the left side. Consequently, the end 30B is pressed downward (specifically, the end 30B is pressed in the downward and front direction as indicated by an arrow A in FIG. 3).

The pressing member 31 is a roller member formed to extend in the width direction and to have a center axis extending in the width direction. The pressing member 31 is rotatably attached to the end 30B of the support member 30. That is, the pressing member 31 is supported by the second guide member 25 via the support member 30. The support member 30 is located to extend from the end 30B at which the pressing member 31 is provided toward the upstream side. That is, the support member 30 extends toward the front side in the upwardly slanting direction.

In the state where the support member 30 is supported on the second guide member 25, the pressing member 31 is situated at the downstream end of the second guide member 25 in the paper carrying direction (i.e., the rear end of the space 40), and the lower part of the outer surface of the pressing member 31 faces the rear end of the upper surface (the first guide surface 24A) of the first guide member 24 from the upper side. Since the support member 30 is able to rotate as described above, the pressing member 31 moves up and down in accordance with the rotational motion of the support member 30, and therefore the pressing member 31 is able to approach and move away from the rear end of the first guide surface 24A. In the normal state, the end 30C of the support member 30 is pressed by the spring 34 and therefore the end 30B is pressed downward. Therefore, the pressing member 31 supported at the end 30B is pressed downward toward the rear end of the first guide surface 24A. If no object exists between the pressing member 31 and the first guide surface 24A, the pressing member 31 contacts the rear end of the first guide surface 24A from the upper side.

The lower surface (specifically, a peripheral part of the rotation center 30A and a rear part with respect to the rotation center 30A) of the support member 30 is formed to connect to the second guide surface 25A and to be exposed to the rear side from the second guide member 25A so as to face the first guide surface 24A. In other words, the support member 30 forms a part of the second guide surface 25A. It is also possible to express that the support member 30 is provided on the second guide surface 25A. As described above, when the support member 30 rotates, the pressing member 31 moves in the vertical direction. Specifically, in this case, the pressing member 31 moves in the direction connecting the rear upper side and the front lower side (i.e., in the direction substantially perpendicular to the second guide surface 25A extending to tilt in the rear and downward direction).

Hereafter, the carrying operation where the sheet of paper 100 is carried from the paper supply cassette 7 to the carrying belt 9 is explained.

As described above, the top of the stack of sheets of paper 100 accommodated in the paper supply cassette 7 is supplied by the carrying rollers 19 provided around the front end of the paper supply cassette 7, to the space between the pair of registration roller 18. Then, the pair of registration roller 18 catch the leading edge of the supplied sheet of paper 100, and send out the sheet of paper 100 toward the carrying belt 9 located on the downstream side in the paper carrying direction while being rotated by predetermined timing. At this moment, the pair of registration rollers 18 send out the sheet of paper 100 while contacting at least the center portion of the sheet of paper 100 in the width direction. In FIG. 3, the leading edge X of the sheet of paper immediately after being sent out from the registration rollers 18 is illustrated.

The sheet of paper 100 sent out from the registration rollers 18 is carried toward the rear side, and enters the space 40 (i.e., space sandwiched by the first guide surface 24A and the second guide surface 25 in the vertical direction) from the front side. After further being carried toward the rear side, the sheet of paper 100 contacts the front end part of the second guide surface 25A. In FIG. 3, the leading edge of the sheet of paper 100 defined at this state is assigned the reference symbol “Y”.

The sheet of paper 100 contacting the front end part of the second guide surface 25A is carried in the downward and rear direction along the second guide surface 25A which tilts in the downward and rear direction. Since the front end part of the second guide surface 25A is curved upward to form the smoothly recessed portion, the sheet of paper 100 contacting the front end part of the second guide surface 25A is able to move along the second guide surface 25A without being folded. Subsequently, the sheet of paper 100 reaches the position where the pressing member 21 and the rear end part of the first guide surface 24A. In FIG. 3, the leading edge of the sheet of paper 100 defined at this stage is assigned the reference symbol Z. As described above, the second guide 25 guides, on the second guide surface 25A, the sheet of paper 100 toward the carrying belt 9 located on the downstream side in the paper carrying direction.

The center portion 100A of the sheet of paper 100 coincides with the pressing member 31 in the width direction (see FIG. 2). Therefore, only the center portion 100A of the sheet of paper 100 reaches the contacting part of the pressing member 31 and the rear end part of the first guide surface 24A. Since the sheet of paper 100 is carried to the rear side from the registration roller 18, the rear end of the first guide surface 24A is at the rear end of the first guide member 24 in the paper carrying direction.

When the center portion 100A of the sheet of paper 100 (i.e., the leading edge Z of the sheet of paper 100) reaches the contacting part of the pressing member 31 and the first guide surface 24A, the upstream part of the sheet of paper 100 is caught by the registration roller 18. Therefore, the sheet of paper 100 is further carried toward the rear side by the registration roller 18.

Therefore, the center portion 100A of the leading edge Z of the sheet of paper 100 presses upward the pressing member 31 against the pressing force produced by the spring 34 to move the pressing member 31 away from the rear end part of the first guide surface 24A. Accordingly, the restoring force of the spring 34 presses the pressing member 31 to return to the rear end part of the first guide surface 24A. In this case, the pressing member 31 presses only the center portion 100A of the sheet of paper 100 toward the first guide surface 24A while sandwiching the center portion 100A between the pressing member 31 and the first guide surface 24A. Therefore, the sheet of paper 100 proceeds toward the rear side between the first guide surface 24A and the second guide surface 25A while receiving, at the center portion 100A, the stronger resistance than the resistance acting on the both ends 100B in the width direction. The entire leading edge Z of the sheet of paper 100 in the width direction passes the pressing member 31 toward the rear side. Thus, the entire sheet of paper 100 is further carried toward the rear side.

When the sheet of paper 100 passes the pressing member 31, only the center portion 100A of the sheet of paper 100 is pressed by the pressing member 31 toward the first guide surface 24A from the upper side, and is sandwiched between the pressing member 31 and the first guide surface 24A. Therefore, in this case, only the center portion 100A receives the resistance acting toward the upstream side. In this case, the part of the sheet of paper 100 other than the center portion 100A also approaches the first guide surface 24A although the part of the sheet of paper 100 other than the center portion 100A is not pressed against the first guide surface 24A. As described above, the first guide surface 24A tilts such that the first guide surface 24 approaches, from upper side, the upper part 9A of the carrying belt 9 toward the rear side. Therefore, the sheet of paper 100 being carried toward the rear side while approaching the first guide surface 24A is guided to the upper part 9A of the carrying melt 9 along the first guide surface 24A. Thus, the first guide member 24 serves to guide the sheet of paper 100 to the carrying belt 9 located on the downstream side on the first guide surface 24A.

Since the pressing member 31 is rotatable, the pressing member 31 presses the center portion 100A of the sheet of paper 100 while rotating in accordance with the movement of the sheet of paper 100, by contacting the upper face of the center portion 100A of the sheet of paper 100 passing between the pressing member 31 and the rear end part of the first guide surface 24A. As described above, the sheet of paper 100 guided to the upper part 9A of the carrying belt 9 is placed on the upper part 9A and is carried to the transfer position. Then, by the process cartridges 13, the image formation is performed on the sheet of paper 100 being carried on the paper carrying unit 20.

As described above, the sheet of paper 100 supplied from the paper feed cassette 7 passes the registration rollers 18, the second guide member 25, the pressing member 31, and the first guide member 24 in this order from the upstream side in the paper carrying direction, and then is supplied to the carrying belt 9. It is understood that the pressing member 31 and the first guide member 24 are located on the upstream side with respect to the carrying belt 9 in the paper carrying direction, and the registration rollers 18 are located on the upstream side with respect to the pressing member 31 in the paper carrying direction.

Hereafter, advantages achieved by the above described embodiment are described.

(1) As described above, the paper carrying device 20 is configured such that a resistance member (e.g., the pressing member 31) and the guide members 24 and 25 are located on the upstream side with respect to the carrying belt 9 in the paper carrying direction.

The pressing member 31 serves to apply, at the center portion 100A of the sheet of paper 100 defined in the width direction perpendicular to the paper carrying direction, the stronger resistance than the resistance acting on the both ends 100B of the sheet of paper 100. More specifically, since the pressing member 31 presses only the center portion 100A, the center portion 100A is pressed against the first guide surface 24A of the first guide member 24 located to face the pressing member 31.

Therefore, on the sheet of paper 100 being carried toward the carrying belt 9, stronger resistance acts on the center portion 100A relative to the both ends 100B of the sheet of paper 100. Such a configuration makes it possible to prevent the center portion 100A from being carried ahead of the other part (i.e., the both ends 100B) of the sheet of paper 100. That is, preceding of the center portion of the sheet of paper can be prevented. Consequently, it becomes possible to smoothly carry the sheet of paper 100.

As shown in FIG. 3, if the pressing member 31 presses at least the leading edge (i.e., the leading edge Z) on the center portion 100A of the sheet of paper 100, not only preceding of the leading edge Z but also the preceding of the upstream region defined from the leading edge Z on the sheet of paper 100 is also prevented. Consequently, it becomes possible to prevent the preceding of the central portion over the entire paper carrying direction on the sheet of paper 100.

If the center portion of the sheet of paper moves to precede the both ends of the sheet of paper 100, a force pointing from the each of the both ends 100B to the center portion 100A acts in the width direction. However, in this case, a force pointing from the center portion 100A to each of the both ends 100B acts on the sheet of paper 100 because the pressing member 31 presses only the center portion 100A. Consequently, the forces acting in the width direction are canceled with each other.

(2) As shown in FIG. 3, the pressing member 31 is used as a resistance member to press the sheet of paper 100 against the first guide member 24. Such a configuration makes it possible to produce resistance only in the center portion 100A in the width direction, and thereby to prevent occurrence of preceding of the center portion of the sheet of paper 100. Consequently, it becomes possible to smoothly carry the sheet of paper 100 to the carrying belt 9.

(3) The pressing member 31 contacts the sheet of paper 100 being carried without receiving a driving force from a motor, and is rotatable with carrying of the sheet of paper 100. Therefore, the pressing member 31 does not produce resistance more than necessary by rotating while the pressing member 31 presses the center portion 100A of the sheet of paper 100. Consequently, it becomes possible to smoothly carry the sheet of paper 100 to the carrying belt 9 while preventing occurrence of the preceding of the center portion.

It should be noted that the pressing member 31 does not contact the carrying belt 9. Therefore, the carrying belt 9 is not worn by the pressing member 31.

(4) The pressing member 31 is able to approach and move away from the first guide surface 24A, and is pressed in a direction to contact the first guide surface 24A by the spring 34. By this structure, the sheet of paper 100 carried to the first guide surface 24A acts to move the pressing member 31 away from the first guide member 24A against the pressing force pointing to the first guide surface 24A. In this case, it is possible to securely apply the resistance to the center portion 100A of the sheet of paper 100 by sandwiching the sheet of paper 100 between the first guide surface 24A and the pressing member 31, and to pass the sheet of paper 100 between the pressing member 31 and the first guide surface 24A.

(5) The pressing member 31 is able to contact the downstream end part of the first guide member 24 defined in the paper carrying direction (i.e., the rear end of the first guide surface 24A closest to the carrying belt 9). Therefore, it is possible to prevent the preceding of the center portion of the sheet of paper 100 at a position immediately before the carrying belt 9. Therefore, the preceding of the center portion does not occur on the sheet of paper 100 being carried toward the carrying belt 9 after passing the pressing member 31. Consequently, the sheet of paper 100 is carried in the state where the preceding of the center portion is prevented, and is supplied to the carrying belt 9 while keeping the state where the preceding of the center portion is prevented.

That is, by preventing the preceding of the center portion of the sheet of paper 100 at the position immediately before the carrying belt 9, it is possible to effectively prevent the sheet of paper 100 from being carried to the carrying belt 9 in the state where the preceding of the center portion occurs.

(6) The rear end part of the first guide surface 24A configured to contact the pressing member 31 is formed as a tilting surface to approach the carrying belt 9 toward the downstream side in the paper carrying direction. By this structure, the sheet of paper 100 proceeding toward the carrying belt 9 after passing the pressing member 31 can be smoothly supplied to the carrying belt 9 while being guided by the first guide surface 24A. Consequently, it is possible to achieve the smooth carrying of the sheet of paper 100.

(7) The first guide surface 24A faces the lower face of the sheet of paper 100, and the second guide surface 25A faces the upper face of the sheet of paper 100. The interval between the first guide surface 24A and the second guide surface 25A becomes wider at a point closer to the upstream end in the paper carrying direction. By this structure, the sheet of paper 100 can be smoothly inserted onto the space between the first guide surface 24A and the second guide surface 25A, and is guided toward the carrying belt 9.

(8) The pressing member 31 is positioned to face the first guide surface 24A to press the sheet of paper 100 against the first guide surface 24A. It is possible to produce the resistance only on the center portion 100A defined on the sheet of paper 100 in the width direction. Therefore, it is possible to prevent occurrence of the preceding of the center portion of the sheet of paper 100. Consequently, it is possible to smoothly carry the sheet of paper 100 toward the carrying belt 9.

(9) The second guide surface 25A has the end 30B at which the pressing member 31 is attached, and the support member 30 is rotatably provided so that the pressing member 31 can move in the direction orthogonal to the second guide surface 25A. Therefore, it is possible to rotate the pressing member 31 by the sheet of paper 100 carried to the second guide surface 25A, and to pass the sheet of paper 100 between the pressing member 31 and the first guide surface 24A while applying the resistance to the sheet of paper 100.

(10) Since the support member 30 which is rotatably provided while supporting the pressing member 31 is provided on the second guide member 25, the pressing member 31 is able to approach and move away from the first guide member 24 by rotating together with the support member 30.

The support member 30 is located to extend toward the upstream side in the paper carrying direction from the end 30B at which the pressing member 31 is attached, and the support member 30 forms a part of the second guide surface 25A. Therefore, the sheet of paper 100 smoothly reaches the pressing member 31 while being guided by the first guide surface 24A and the second guide surface 25A (including a part of the support member 30 forming the second guide surface 25A). Consequently, the preceding of the center portion can be prevented securely.

More specifically, the support member 30 is positioned such that the end 30B is situated on the downstream side with respect to the end 30C in the paper carrying direction, and that the support member 30 tilts toward the downward and rear side so that the end 30B approaches the sheet of paper 100 toward the downstream side in the paper carrying direction.

By this structure, if the pressing member 31 provided at the end 30B moves down and approaches the first guide surface 24A while the end 30C is pressed by the spring 34, the pressing member 31 is able to apply a part (i.e., a component force C illustrated by a dotted line in FIG. 3) of the pressing force of the spring 34 (i.e., the pressing force A illustrated in FIG. 3 to point to the downward and upstream direction) to the sheet of paper 100 as a force pointing to the upstream side while pressing the center portion 100A of the sheet of paper 100 passing between the pressing member 31 and the first guide surface 24. In FIG. 3, another component force C perpendicularly acting with respect to the component force B is also illustrated in FIG. 3. Consequently, the resistance is produced only in the center portion 100A of the sheet of paper 100. It becomes possible to securely prevent occurrence of the preceding of the center portion of the sheet of paper 100.

Since the support member 30 is tilted, the pressing member 31 is able to move away from the first guide member 24 by the reactive force from the sheet of paper 100 while pressing the sheet of paper 100. Therefore, the sheet of paper 100 is able to smoothly pass between the pressing member 31 and the first guide member 24.

It should be noted that the support member 30 may be formed such that the support member 30 extends toward the downstream side from the end 30B at which the pressing member 31 is attached and the rotation center is positioned on the downstream side with respect to the pressing member 31. However, in regard to suitably achieving the above described motion where the sheet of paper 100 lifts the pressing member 31 to swing the support member 30, the above described structure of the support member 30 (which is configured to have the rotation center 30A on the upstream side with respect to the pressing member 31) is advantageous.

More specifically, when the end 30C is located on the downstream side with respect to the end 30B in the paper carrying direction, and the support member 30 is formed to tilt in the downward and front direction toward the end 30B so that the end 30B side of the support member 30 approaches the sheet of paper 100 toward the upstream direction, the pressing member 31 is not able to press the sheet of paper 100. Rather, in this case, the pressing member 31 is pressed toward the first guide member 24, and blocks the space between the pressing member 31 and the first guide member 24. In this case, the sheet of paper 100 is not able to pass between the first guide member 24 and the pressing member 31, and therefore paper gamming will occur.

The sheet of paper 100 is guided by not only the first guide member 24 but also the second guide member 25. Consequently, the sheet of paper can be smoothly guided to the carrying belt 9.

Since the pressing member 31 is supported by the second guide member 25 via the support member 30, the second guide member 25 also serves both as a guiding member for the sheet of paper 100 and a support member for the pressing member 31. Such a configuration makes it possible to reduce the number of components in the printer 1.

By contrast, if the second guide member 25 does not support the pressing member 31, it becomes necessary to provide an axial member (e.g., a metal axis) to bridge the side walls 21A and 21B of the frame 21 so that the axis member supports the pressing member 31. In this case, the total cost increases in comparison with the above described embodiment.

(11) In the above described embodiment, the carrying belt 9 and the guide members 24 and 25 are provided on a single frame (the frame 21). Such a configuration makes it possible to stably position the carrying belt 9, the guide members 24 and 25 and the resistance member (the pressing member 31). In addition, since the resistance member (the pressing member 31) and the carrying belt 9 are provided on the same frame 21, it becomes possible to position the resistance member (the pressing member 31) closely to the carrying belt 9. Consequently, it becomes possible to stably prevent occurrence of the preceding of the center portion of the sheet of paper 100 immediately before the carrying belt 9.

(12) The carrying belt 9 has the carrying surface (the upper part 9A) on which the sheet of paper 100 is placed, and the first guide member 24 has the first guide surface 24A formed to approach the upper part 9A toward the downstream side in the paper carrying direction so as to guide the sheet of paper 100 on the first guide surface 24A. Therefore, by guiding the sheet of paper 100 on the first guide surface 24A, it is possible to smoothly supply the sheet of paper 100 to the carrying belt 9. Therefore, it becomes possible to smoothly carry the sheet of paper 100 while preventing occurrence of the preceding of the center portion of the sheet of paper 100.

(13) The printer 1 provided with the paper carrying unit 20 is able to prevent occurrence of the preceding of the center portion of the sheet of paper 100 and thereby to prevent creases from being produced on the sheet of paper 100. Therefore, it is possible to enhance the quality of image formation.

(14) The registration roller 18 located on the upstream side in the paper carrying direction contact al least the center portion 100A of the sheet of paper 100 to send out the sheet of paper 100 toward the pressing member 31 located on the downstream side in the paper carrying direction at predetermined timing. In this case, the center portion 100A is inevitably prone to be carried easily in comparison with the both ends 100B in the width direction. Therefore, the preceding of the center portion of the sheet of paper may occur on the sheet of paper 100 immediately after passing through the registration rollers 18. However, thanks to the pressing member 31, the occurrence of the preceding of the center portion of the sheet of paper can be prevented.

(Variations)

Hereafter, variations of the above described embodiment are described.

(First Variation)

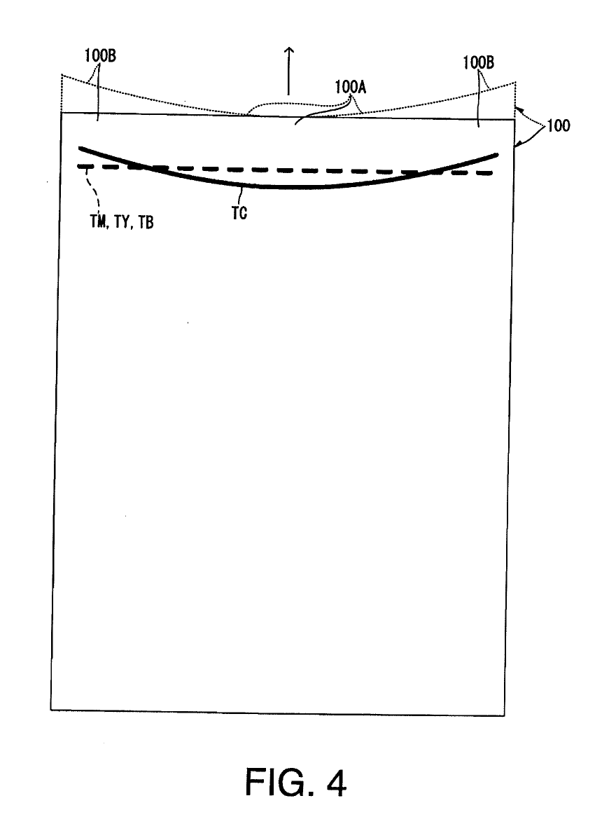

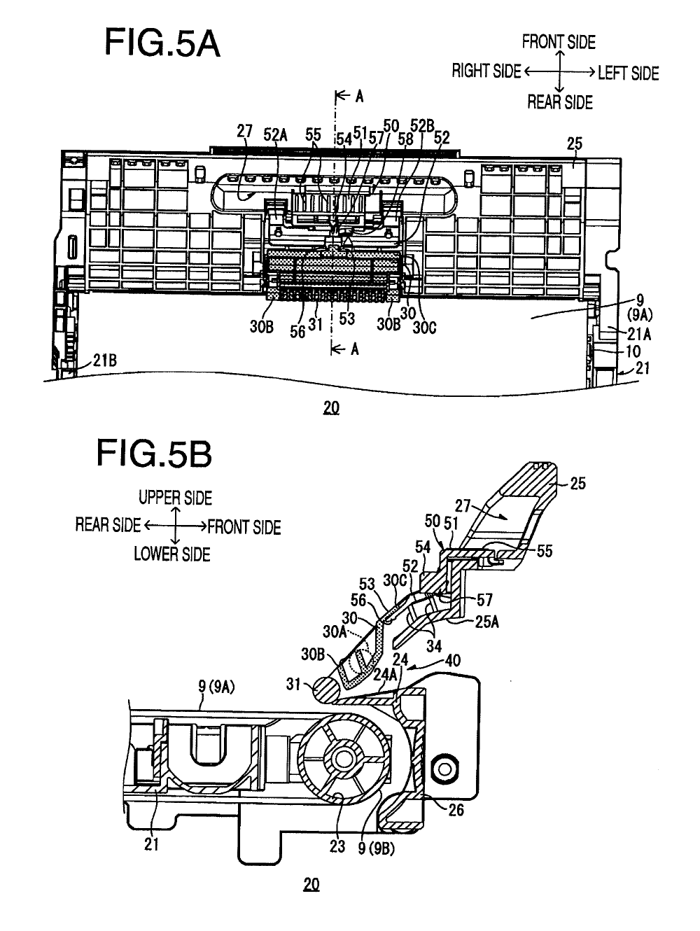

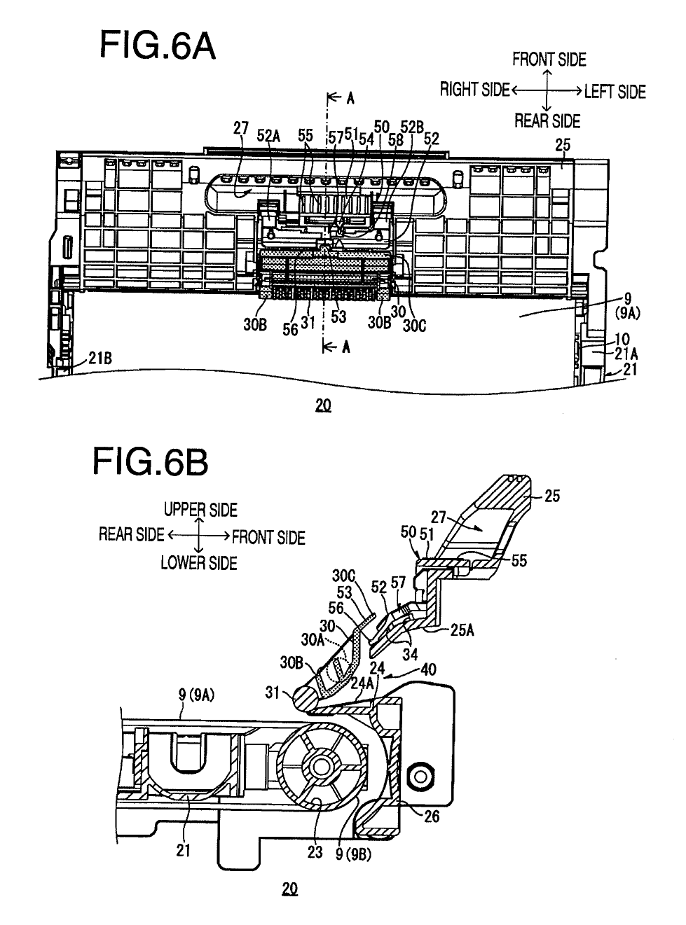

FIG. 4 is an explanatory illustration for explaining shift of image transfer caused by the preceding of the center portion of the sheet of paper 100. FIGS. 5A and 5B illustrate the paper carrying unit according to the first variation. More specifically, FIG. 5A is a plan view illustrating the main part of the paper carrying unit according to the first variation. In FIG. 5A, the pressing member 31 is in the pressing state. FIG. 5B is a cross section viewed along the line A-A in FIG. 5A. FIGS. 6A and 6B illustrate the state where the pressing member 31 is in the released state.

Referring to FIG. 2, under the high temperature and humidity state, the sheet of paper is prone to be in the state where the center portion 100A is dry (hard) and the both ends 100B are moisty (soft). If the preceding of the center portion occurs in such a state, each force pointing from the end 100B to the center portion 100A and the elasticity of the paper in the center portion 100A repel one another. In this case, creases causing the transferring error of the toner image may be produced in the center portion 100A.

For this reason, in the above described embodiment, the pressing member 31 presses only the center portion 100A of the sheet of paper 100 against the first guide member 24 so that the stronger resistance is produced in the center portion 100A relative to the resistance acting on the both ends 100B. Consequently, occurrence of the preceding of the center portion can be prevented.

However, because the pressing force applied to the center portion 100A from the pressing member 31 is relatively larger, if the resistance which is more than necessary is caused in the center portion 100A, a phenomenon where carrying of the center portion 100A is delayed with respect to the carrying of the ends 100B occurs at the leading edge portion of the sheet of paper 100, as indicated by a dotted line in FIG. 4. It should be noted that this phenomenon occurs due to the pressing force of the pressing member (i.e., the pressing force A by the spring 34). Therefore, the phenomenon occurs regardless of the environmental condition such as temperature or humidity, and the type of the sheet of paper 100.

After a period of time has passed since the leading edge of the sheet of paper has passed the space between the pressing member 31 and the first guide member 24, the resistance acting on the center portion 100A of the sheet of paper 100 at the leading edge becomes smaller, and thereby the above described phenomenon disappears. Therefore, if the resistance which is more than necessary is caused in the center portion 100A, the state where the carrying of the center portion 100A is delayed with respect to the carrying of the both ends 100B continues for a while, and thereafter the sheet of paper 100 is carried properly such that the center portion 100A and the ends 100B are carried equally in the width direction.

On the leading edge portion of the sheet of paper 100 immediately after passing through the space between the pressing member 31 and the first guide member 24, the toner image of the photosensitive drum 3 closest to the first guide member 24 is transferred first, and thereafter, the toner images of other colors (magenta, yellow and black) are overlaid on the cyan toner image on the sheet of paper 100 (see FIG. 1).

However, at the leading edge portion of the sheet of paper 100 immediately after passing through the space between the pressing member 31 and the first guide member 24, the sheet of paper 100 is carried in the state where the center portion 100A is delayed with respect to the ends 100B. That is, the center portion 100A and the ends 100B are not aligned equally in the width direction. Accordingly, if a tone image transferred from each photosensitive drum 3 to the sheet of paper 100 is a line extending in the width direction, the cyan toner image TC (indicated by a thick solid line in FIG. 3) is deformed in a formed of a letter U in the leading edge portion of the sheet of paper 100.

On the other hand, in the leading edge portion of the sheet of paper 100 after a period of time has elapsed from the time when the sheet of paper 100 has passed the space between the pressing member 31 and the first guide member 24, the center portion 100A and the both ends 100B are aligned in the width direction. Therefore, toner images (TM, TY, TB) having the colors (magenta, yellow and black) other than the cyan color are transferred to the leading edge portion of the sheet of paper 100 while keeping a proper shape extending in the width direction as indicated by a thick dashed line in FIG. 4.

In this case, the cyan toner image TC transferred to the leading edge portion of the sheet of paper 100 in the shape of a letter of U and the toner images TM, TY and TB transferred to the leading edge portion of the sheet of paper 100 do not overlap with each other. That is, the “transfer shift” is caused.

For this reason, in this variation, a switch member 50 is provided on the paper carrying unit 20 in order to prevent occurrence of “transfer shift”. Regarding the switch member 50, the support member 30 (which is filled with dots) according to this variation is not provided with the boss 32. At the front end (the end 30) of the support member 30, a projection 53 protruding toward the front side is integrally formed with the support member in the center portion in the width direction.

As shown in FIG. 5B, the switch member 50 includes a slide member 51, an adjustment member 52 and the spring 34.

The slide member 51 is a plate-like member having a longer side extending in the width direction. The slide member 51 is slidably supported by a part of the upper surface of the second guide member 25 formed as a fringe surrounding the long hole 27 (see FIG. 5A).

More specifically, the cross section of the slide member 51 viewed along the width direction is formed to extend upward, to bend at a right angle and to extend toward the front side. That is, the slide member 51 has an L-shape when viewed along the width direction.

At a center portion of a rear surface of a part of the slide member 51 extending upward, a projection 54 protruding to the rear side is integrally formed (see FIG. 5A). The projection 54 has a rectangular shape tapering toward the downward side when viewed from the rear side.

On an upper surface of a part of the slide member 51 extending toward the front side, a plurality of ribs 55 each of which extends in the back-and-forth direction and slightly protrudes upward are arranged at predetermined intervals in the width direction.

The slide member 51 is slidable between a first position defined at the rightward area as shown in FIG. 5A and a second position defined at the leftward area as shown in FIG. 6A. When the user slides the slide member 51 by pinching the slide member 51, the ribs 55 serve as stoppers.

As shown in FIG. 5A, the adjustment member 52 has a plate-like member configured to have a form of a letter U and to be opened toward the front side when viewed as a plan view.

In a center portion of the adjustment member 52 in the width direction, a projection 56 protruding toward the rear side is integrally formed. Further, a notch 57 is formed at the front periphery of the adjustment member 52 in the center portion in the width direction. At the left position continuously connected with the position of the notch 57 in the center portion on the upper surface of the adjustment member 52, a projection 58 protruding upward is integrally formed. The upper surface of the projection 58 is formed to extend in a slanting direction toward the upper left side from the left edge of the notch 57 and to extend toward the left side to be flat.

The adjustment member 52 is attached to the second guide member 25 to sandwich the slide member 51 in the width direction. In this state, free ends 52A and 52B of the adjustment member 52 are located at both ends of the slide member 51 in the width direction. The projection 54 of the slide member 51 situated at the first position is fitted into the notch 57 from the upper front side. Furthermore, the projection 56 is inserted under the projection 53 of the support member 30 (see also FIG. 5B).

Each of the free ends 52A and 52B are supported rotatably about the axial direction by the second guide member 25. Therefore, the center portion of the adjustment member 52 is able to swing in the vertical direction with respect to the free ends 52A and 52B.

The rear part of the adjustment member 52 with respect to the free ends 52A and 52B are located to face the upper surface of the second guide member 25 from the upper side, and the spring 34 is inserted between the adjustment member 52 and the second guide member 25 (see FIG. 5B9.

The adjustment member 52 is pressed upward by the spring 34 having the elastic force to extend upward. When the slide member 51 is situated at the first position, the projection 54 fits into the notch 57, and the adjustment member 52 is not pressed from the upper side. Therefore, in this case, the projection 56 is moved upward by the pressing force from the spring 34, and presses upward the projection 53 of the support member 30 from the lower side. With this configuration, the entire support member 30 is pressed to rotate in the counterclockwise direction when viewed from the left side, the pressing member 31 is pressed downward to move toward the rear end of the first guide surface 24A so as to contact the first guide surface 24A. Hereafter, frequently the state of the pressing member 31 contacting the first guide surface 24A is referred to as a “pressing state”.

In the pressing state of the pressing member 31, only the center portion 100A of the sheet of paper 100 is pressed by the pressing member 31 and therefore only the center portion 100A receives the resistance pointing to the upstream side in the paper carrying direction. Therefore, the preceding of the center portion can be prevented. As described above, when the slide member 51 is situated at the first position, the adjustment member 52 lets the spring 34 press the pressing member 31, and the pressing member 31 is in the pressing state.

On the other hand, when the slide member 51 at the first position is slid to the left side, the projection 54 which was fitted into the notch 57 starts to slide leftward and to ride on the projection 58. Therefore, the adjustment member 52 is pressed by the projection 54 from the upper side, and moves downward against the pressing force of the spring 34. In this case, the projection 56 of the adjustment member 52 starts to move downward away from the projection 53 of the support member 30.

When the slide member 51 slides further leftward and reaches the second position a shown in FIG. 6A, the projection 54 completely ride on the projection 58, and is placed on the left end of the projection 58. Accordingly, the adjustment member 52 moves to the lower limit position by pressed by the projection 54 from the upper side, and the projection 56 of the adjustment member 52 completely moves away from the projection 53 of the support member 30 (see also FIG. 6B).

As shown in FIG. 6B, since the support member 30 does not apply the pressing force from the spring via the projection 56 of the adjustment member 52, the entire supporting member 30 is not pressed to rotate in the counterclockwise direction when viewed from the left side. Consequently, the pressing member 31 is not pressed to move toward the rear end of the first guide surface 24A, and the pressing of the pressing member 31 against the first guide surface 24A is released. This state of the pressing member 31 is frequently referred to as a “pressing-released state” hereinafter. The pressing member in the pressing-released state may contact the first guide surface 24A or may be at the moved state moved upward from the first guide surface 24A.

As described above, when the slide member 51 is at the second position, the adjustment member 52 releases the pressing state of the pressing member 31 by the spring 34, and the pressing member 31 is in the pressing-released state.

When the pressing member 31 is in the pressing-released state, the pressing member 31 does not press the sheet of paper 100 against the first guide surface 24A while the sheet of paper 100 passes the pressing member 31. Therefore, it is prevented that resistance is applied only to the center portion 100A of the sheet of paper 100. Consequently, the sheet of paper 100 is carried in the state where the center portion 100A and the both ends 100B are aligned in the width direction. Therefore, occurrence of the transfer shift can be prevented.

As described above, by switching between the pressing state and the pressing-released state of the pressing member 31b sliding the sliding member 51 between the first position and the second position, it becomes possible to switch the pressing force (i.e., the pressing force A acting as a pressing load of the pressing member 31 applied to the sheet of paper 100 passing the pressing member 31) acting to contact the pressing member 31 with the first guide surface 24A.

In the normal state (i.e., in the proper temperature and humidity condition where no crease is cased even if the preceding of the center portion of paper is cased), the pressing member 31 is brought to the pressing-released state so as to prevent occurrence of the transfer shift preferentially. On the other hand, in the high temperature and humidity condition, the pressing member 31 is moved from the pressing-released state to the pressing state to prevent occurrence of the preceding of the center portion preferentially because in this condition the sheet of paper 100 is prone to cause creases due to the preceding of the center portion. That is, the user is able to prevent occurrence of the transfer shift or occurrence of creases by congaing the state of the pressing member 31 in accordance with what phenomenon the user want to avoid preferentially. It should be noted that the switching of the state of the pressing member 31 is conducted in the state where the paper carrying unit 20 is removed from the body casing 2.

As described above, the switch member 50 switches the pressing force A to be applied to the first guide surface 24A. Therefore, by strongly pressing the pressing member 31 against the first guide surface 24A, it is possible to prevent occurrence of the preceding of the center portion (see FIGS. 5A and 5B). On the other hand, if the environmental condition changes to the condition where the sheet of paper 100 does not cause creases due to the preceding of the center portion (i.e., in the condition where the prevention of the preceding of the center portion is not required), it is possible to release the state where the center portion 100A in the width direction receives stronger resistance than the resistance acting on the both ends 100B by switching the pressing state of the pressing member 31 to the pressing-released state. Therefore, it is possible to prevent occurrence of the transfer shift of toner images on the sheet of paper 100 due to the fact that the center portion 100A receives stronger resistance than the resistance acting on the both ends 100B (see FIG. 4).

The switch member 50 has the slide member 51 slidable in the width direction between the first position and the second position, the spring 34 pressing the pressing member 31 to contact the first guide surface 24A, and the adjustment member 52. Since the adjustment member 52 lets the spring 34 press the pressing member 31, the adjustment member 52 is able to move the pressing member 31 to the pressing state (see FIG. 5B).

On the other hand, when the sliding member 51 is at the second position, the adjustment member 5 let the spring 34 release the pressing with respect to the pressing member 31. Therefore, it is possible to move the pressing member 31 to the pressing-released state (see FIG. 6B).

That is, the by simply slide the sliding member 51, it is possible to easily switch the pressing force A acting to contact the pressing member 31 with the first guide surface 24A. Since the sliding member 51 is located at the center portion of the second guide member 25 in the width direction (see FIGS. 5A and 6A), it is possible to find the sliding member 51 in order to operate the sliding member 51.

(Second Variation)

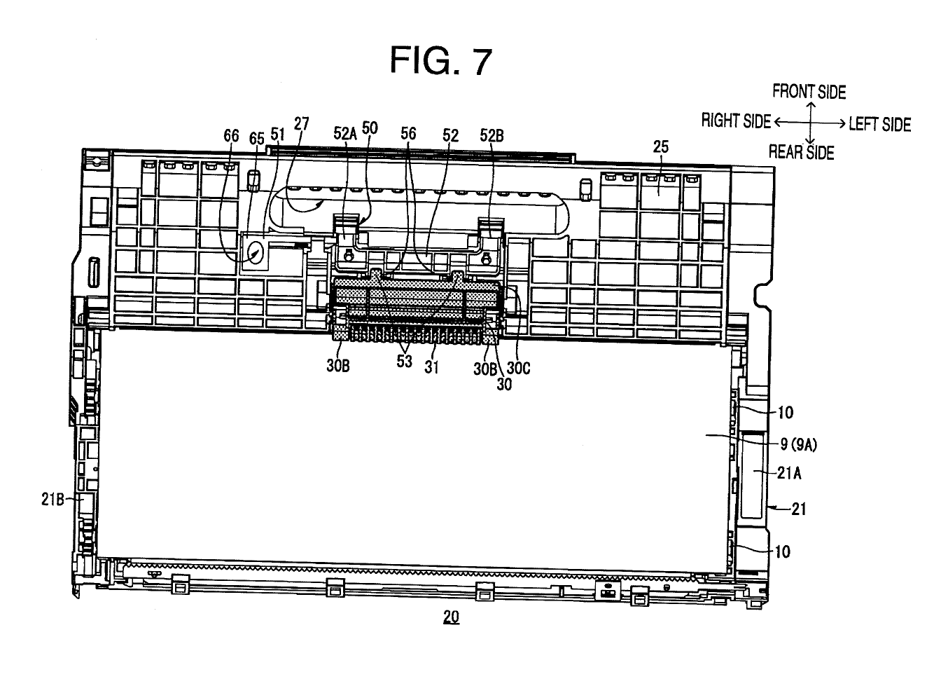

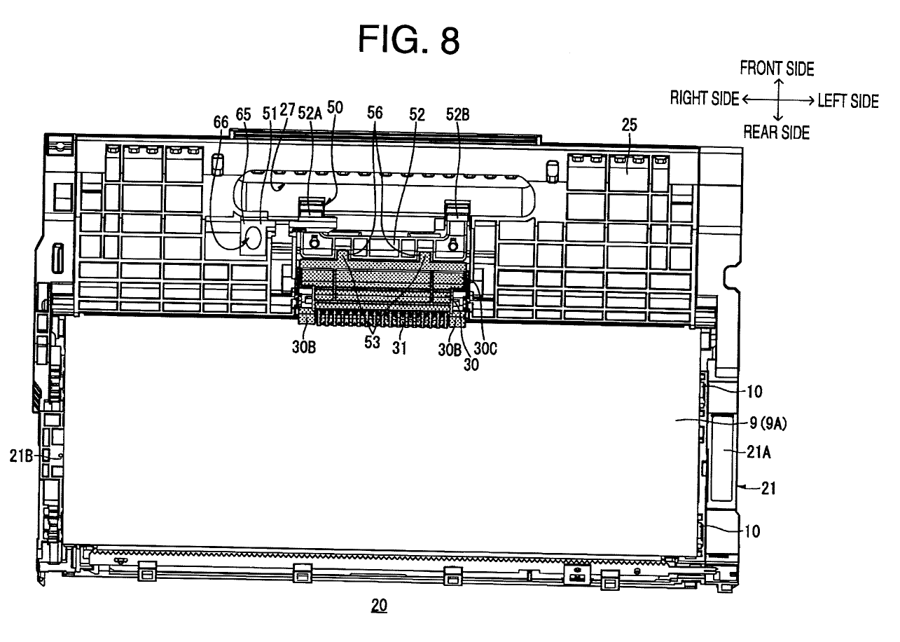

Hereafter, a second variation of the embodiment is described. FIG. 7 is a plan view illustrating a paper carrying unit according to a second variation. In FIG. 7, a state where a pressing member is in a pressing state is illustrated. FIG. 8 illustrates a state where the pressing member is in a pressing-released state.

In the second variation, a sliding member 51B is provided at a position shifted in the width direction from a center (i.e., a position sandwiched by the adjustment member 52) of the second guide member 25 in the width direction. In FIGS. 7 and 8, the sliding member 51B is provided at the positioned shifted rightward in the width direction.

The sliding member 51B according to the second variation has a shape different from the shape of the sliding member 51 according to the first variation. More specifically, the sliding member 51 has a stick-like shape extending in the width direction. At a right end of the sliding member 51B, a grip part 65 having a form of a rectangular plate is integrally formed. A hole 66 is formed in the grip part 65.

The sliding member 51 is supported at the right side of the adjustment member 52 on the upper surface of the second guide member 25 to be slidable in the width direction. More specifically, the sliding member 51 is slidable in the width direction between a rightward position (first position) shown in FIG. 7 and a leftward position (second position) shown in FIG. 8. The user is able to slide the sliding member 51 by gripping the grip part 65 and hooking the user's finger to the hole 66.

As shown in FIG. 7, when the sliding member 51 is at the first position, the sliding member 51 does not contact the adjustment member 52 at any points on the sliding member 51. Therefore, as in the case of the first variation, the projection 56 is moved upward by the pressing force of the spring 34 (see FIG. 5B) to press the projection 53 of the support member 30 downward. In this case, the pressing member 31 as well as the support member 30 are pressed, and the pressing member 31 is in the pressing state. It should be noted that in the second variation two projections 53 and two projections 56 are provided.

On the other hand, when the sliding member 51 is slide to the second position shown in FIG. 8, the left end of the sliding member situated at the second position rides on the free end 52A provided on the left side on the adjustment member 52, and presses the adjustment member 52 to move the adjustment member 52 to the lower limit position. In this case, as in the case of the first variation, the projection 56 of the adjustment member 52 moves downward away from the projection 53, and thereby the pressing member 31 moves to the pressing-released state (see FIG. 6B).

(Third Variation)

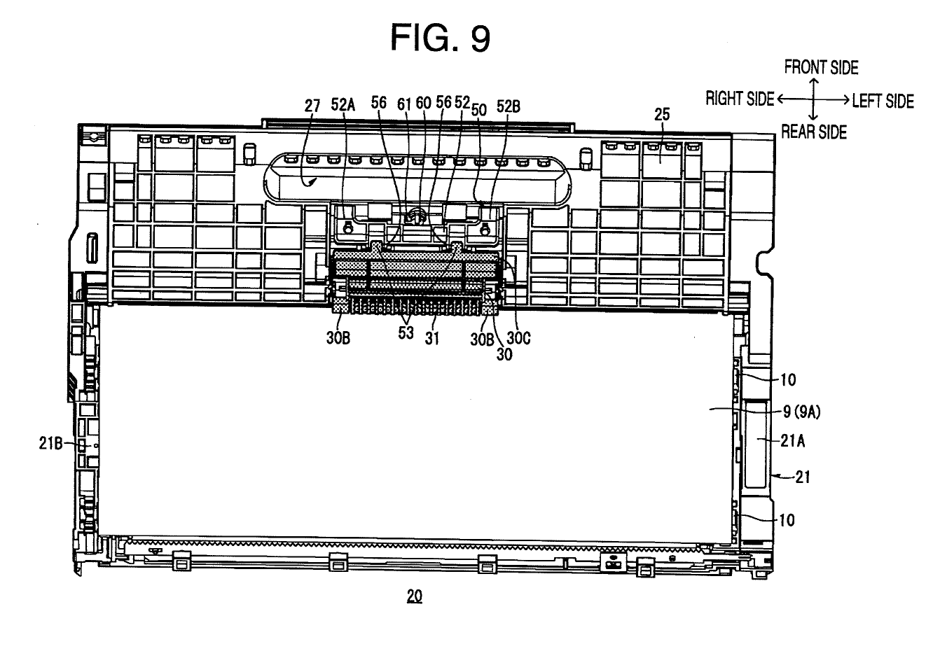

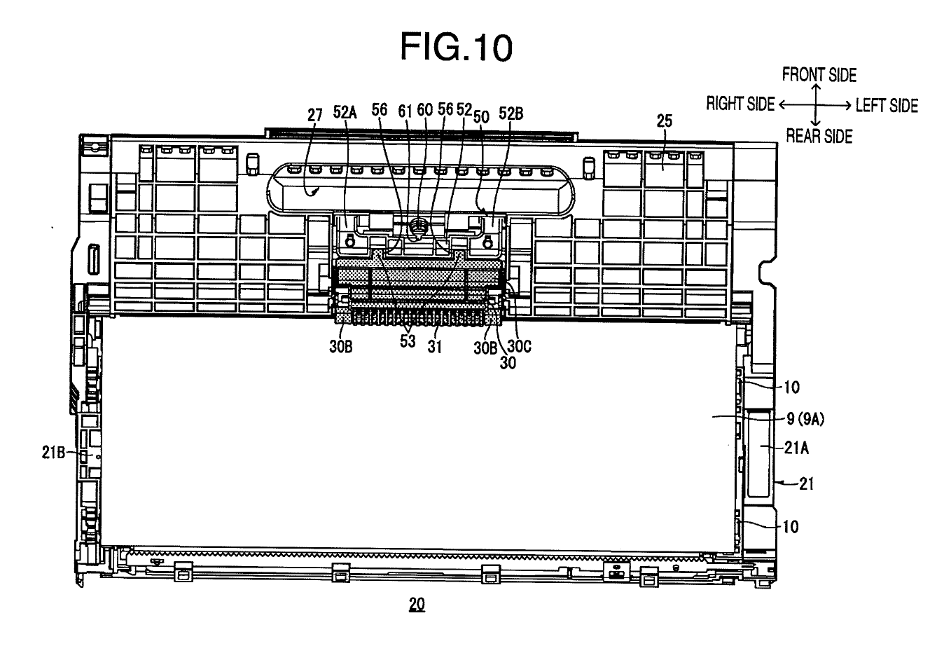

Hereafter, a third variation of the embodiment is described. FIG. 9 is a plan view illustrating a paper carrying unit according to a third variation. In FIG. 9, a state where a pressing member is in a pressing state is illustrated. FIG. 10 illustrates a state where the pressing member is in a pressing-released state.

In the third variation, a twisting member 60 is provided in place of the sliding members 51 and 51B of the first and second variations. The twisting member 60 has a cylindrical shape projecting toward the upper rear side from the portion sandwiched by the adjustment member 52 in the width direction on the upper surface of the second guide member 25. At a position on the outer circumferential surface of the twisting member 60, a projection 61 protruding in the radial direction is provided.

The twisting member 60 is supported on the second guide member 25 to be rotatable about the center of the twisting member 60. More specifically, the twisting member 60 is rotatable between a first position at which the projection 61 points to the right side as shown in FIG. 9 and a second position at which the projection 61 points to the lower side as shown in FIG. 10.

As shown in FIG. 9, when the twisting member 60 is situated at the first position, the twisting member 60 does not contact the adjustment member at any points on the twisting member 60. Therefore, as in the case of the first and second variations, the projection 56 of the adjustment member 52 moves upward by the pressing force of the spring 34, and presses upward the projection 53 of the support member 30. Therefore, in this case, the pressing member 31 as well as the support member 30 are pressed, and the pressing member 31 is in the pressing state.

On the other hand, when the twisting member at the first position is rotated to the second position shown in FIG. 10, the projection 61 of the twisting member 60 pointing the lower side presses the adjustment member 52 to move the adjustment member 52 to the lower limit position. Therefore, as in the case of the first and second variations, the adjustment member 52 moves completely away from the projection 53 of the support member 30 in the downward direction, and thereby the pressing member 31 moves to the pressing-released state.

(Other Variations)

In the above described embodiment, the pressing member 31 provided at the ends 30B of the support member 30 is pressed toward the sheet of paper 100 through use of the spring 34 (see FIG. 3). However, the spring 34 may be omitted, and the pressing member 31 may be pressed toward the sheet of paper 100 by the support member 30's own weight or the pressing member 31's own weight.

In place of the support member 30, the spring 34 and a roller-like pressing member 31, a elastic film may be used as a pressing member. In this case, the film may be provided such that an end of the film is attached to the paper carrying unit 20 and a tip (i.e., the other end) of the film is positioned to contact the first guide surface 24A in a deformed state. In this case, the tip of the film serves as a pressing member (i.e., the pressing member 31) to press the center portion 100A of the sheet of paper 100.

In the above described embodiment, the pressing member 31 is attached to the second guide member 25. However, the pressing member 31 may be attached to the first guide member 24. In this case, the pressing member 31 is provided on the first guide surface 24A of the first guide member 24 so as to face the second guide surface 25A of the second guide member 25 from the lower side (in this case, the supporting member 30 is also provided on the first guide surface 24A). Consequently, the pressing member 31 presses the center portion 100A of the sheet of paper against the second guide surface 25A.

A friction resistance member may be provided on one of the guide surface of the first guide surface 24A and the guide surface of the second guide surface 25A at a center portion in the width direction around the downstream end portion in the paper carrying direction to contact the sheet of paper 100. The friction resistance member may be formed as bumps and dips on the guide surface or may be made of rubber. In this case, on the sheet of paper 100 carried to the space between the first guide surface 24A and the second guide surface 25A, only the center portion 100A contacts the friction resistance member. Therefore, it is possible to give resistance only to the center portion 100A, and thereby it becomes possible to prevent occurrence of the preceding of the sheet of paper 100. The friction resistance member is not required to have the function of pressing the sheet of paper 100 against the first guide surface 24A as in the case of the pressing member 31. That is, by only contacting the center portion 100A of the sheet of paper 100, the friction resistance member is able to prevent occurrence of the preceding of the center portion.

In the above described embodiment, the printer is configured to form an electrostatic latent image by exposing the photosensitive drum 3 with the LED. However, the above described feature of the embodiment may be applied to a laser printer. In the above described embodiment, the sheet of paper is carried by the carrying belt 9. However, the feature of the above described embodiment may be applied to an image forming device of a type configured to carry the sheet of paper by holding the sheet of paper between a pair of rollers.

The above described feature may also be applied to an image reading device configured to carry a recording medium to read an image formed on the recording medium.

### Second Embodiment

Hereafter, a second embodiment is described. In the second embodiment, to elements which are substantially the same as those of the first embodiment, the same reference numbers are assigned for the sake of simplicity.

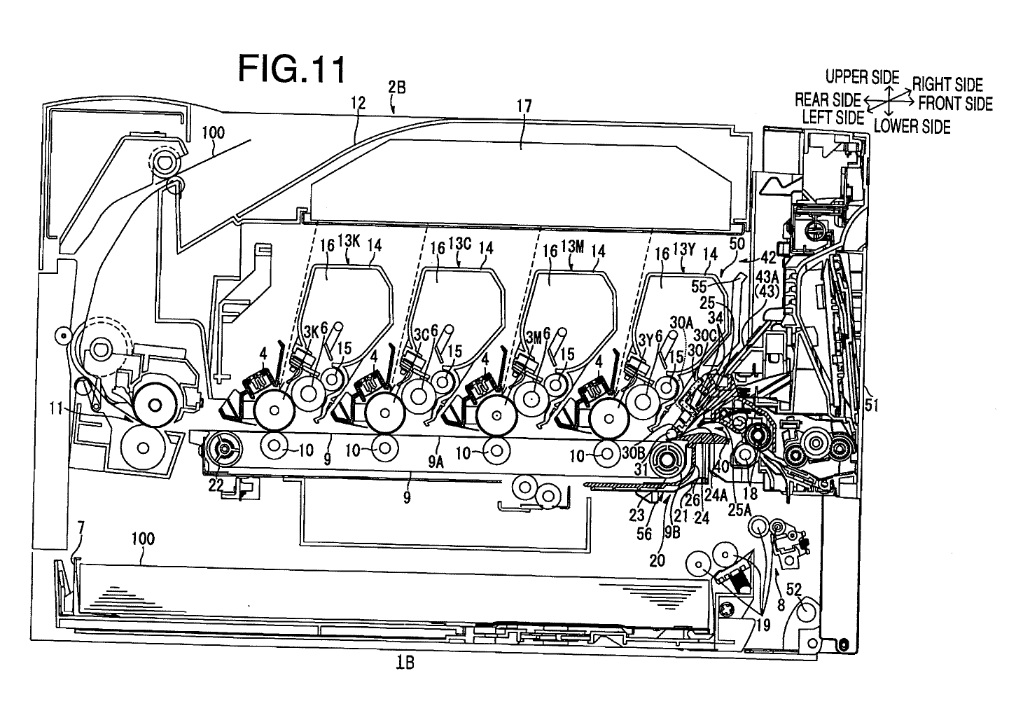

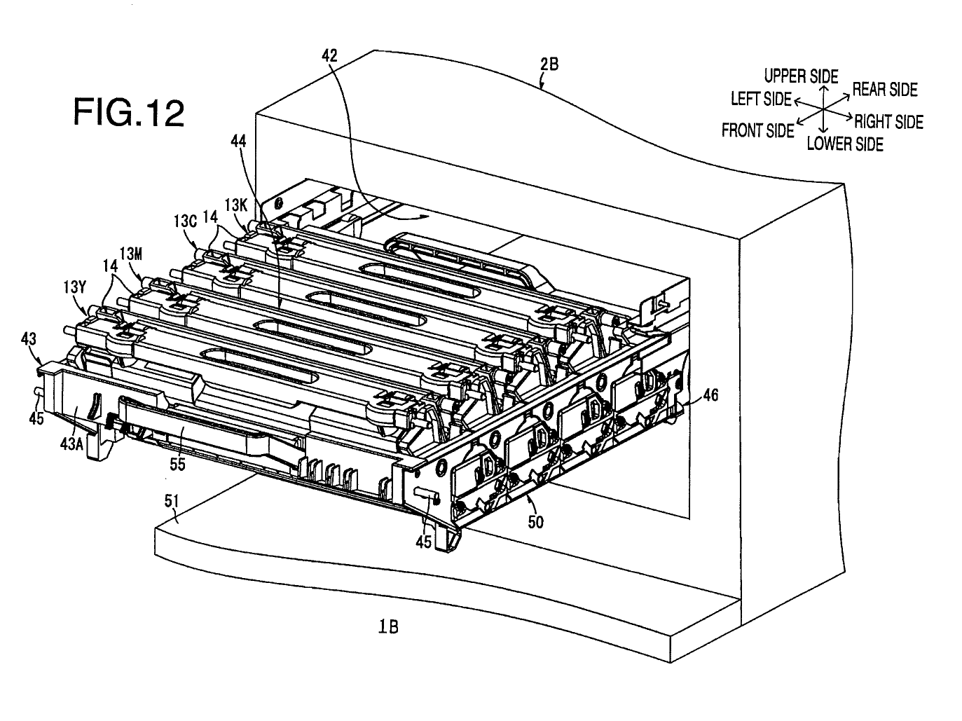

FIG. 11 is a side cross section of a printer 1B according to the second embodiment. FIG. 12 is a perspective view of the printer 1B viewed from the front right side. In FIG. 12, a situation where a process unit (a photosensitive member unit) is attached to or detached from a body casing is illustrated.

The printer 1 is a color printer. As shown in FIG. 11, the printer 1B has a body casing 2B having a box shape having a longer side in the front-and-back direction. In the body casing 2B of the printer 1B, four photosensitive drums 3 are provided to be rotatable, and are arranged in parallel with each other along the back and forth direction. In the following, in accordance with colors of toner (black, cyan, magenta and yellow), the four photosensitive drums 3 are defined as a photosensitive drum 3K (for black color), a photosensitive drum 3C (for cyan color), a photosensitive drum 3M (for magenta color), and a photosensitive drum 3Y (for yellow color). In the following, frequently the four photosensitive drums 3K, 3Cm 3M and 3Y are generically called the photosensitive drum 3 for the sake of simplicity.

After a surface of the photosensitive drum 3 is uniformly charged by a scorotron type charger 4, the surface of the photosensitive drum 3 is exposed by a laser beam emitted by a scanning unit 17 provided on the upper side in the body casing 2B. By this structure, an electrostatic latent image based on image data is formed on the photosensitive drum 3. The electrostatic latent image is visualized by toner (developer) held on a development roller 6 corresponding to the photosensitive drum 3. That is, a toner image is formed on the surface of the photosensitive drum 3.

Sheets of paper 100 which are examples of a sheet-like recording medium are accommodated in a paper supply cassette 7 provided at the bottom of the body casing 2B such that the sheets of paper 100 are stacked in the vertical direction. The top of the stacked sheets of paper 100 is fed and carried by rollers provided in a paper supply part 8 around the front end portion of the paper supply cassette 7 to move upward and to turn from the front side toward the rear side, and is carried by a carrying belt 9 serving as a carrying unit. The rollers provided around the paper supply part 8 include a pair of registration rollers 18. The registration rollers 18 carry the sheet of paper 100 supplied from the paper supply cassette 7 to the carrying belt 9 at predetermined timing. It should be noted that the recording medium includes an OHP sheet as well as a sheet of paper.

The carrying belt 9 is provided between the photosensitive drums 3K, 3C, 3M and 3Y and transfer rollers 10. The toner images respectively formed on the photosensitive drums 3K, 3C, 3M and 3Y are transferred to the sheet of paper 10 by a transfer bias applied to the transfer roller 10 so that the toner images are overlaid appropriately.

The sheet of paper 100 to which the four color toner images have been transferred is carried by the carrying belt 9 to a fixing unit 11 provided on the rear side. Then, the toner image transferred on the sheet of paper 100 is fixed by the fixing unit 11 by heat. Thereafter, the sheet of paper 100 is moved upward while altering the moving direction from the rear side toward the front side, and is ejected to the output tray 12 provided on the upper side of the body casing 2B.

As described above, the sheet of paper 100 is carried from the paper supply cassette 7 to the output tray 12 while being moved in the vertical direction and/or in the back-and-forth direction.

The printer 1 includes four process cartridges 13 functioning as image formation units. In the following, in accordance with colors of toner (black, cyan, magenta and yellow), the four process cartridges 13 are defined as a process cartridge 13K (for black color), a process cartridge 13C (for cyan color), a process cartridge 13M (for magenta color), and a process cartridge 13Y (for yellow color). In the following, frequently the four process cartridges 13K, 13C, 13M and 13Y are generically called the process cartridge 13 for the sake of simplicity.

The process cartridges 13K, 13C, 13M and 13Y are arranged in parallel with each other along the back-and-forth direction in the body casing 2B.

In a casing (a process casing 4) of each process cartridge 13, the photosensitive drum 3, the scorotron type charger 4, the development roller 6 and a supply roller 15 and a toner hopper 16 are provided. A center axis of each of the photosensitive drum 3, the development roller 6 and the supply roller 15 extends in the width direction. In the process cartridge 13, the toner stored in the toner hopper 16 is supplied to the development roller 6 by the supply roller 15, and the toner is held on the development roller 6 as described above.

The process cartridges 13 are integrated as a unit, and hereafter are collectively called a process unit 50 (see FIG. 11). At the front end of the process unit 50, a handle 55 is provided. In the process unit 50, the photosensitive drum 3 is held in each process cartridge 13, and is detachably attached to the body casing 2B.

On the front wall of the body casing 2B, a cover 51 which has a rectangular plate-like shape when viewed as a front view is provided. The cover 51 is supported on the front wall of the body casing 2B so as to be able to swing with respect to a rotation axis 52 provided at the lower edge of the front wall of the body casing 2B. The rotation axis 52 extends in the width direction. The cover 51 is movable between a position (hereafter, referred to as a close position) at which the cover 51 stands in the vertical direction as shown in FIG. 11 and a position (hereafter, referred to as a removed position) at which the cover 51 tilts toward the front side to be oriented in substantially horizontal direction as shown in FIG. 12.

The cover 51 situated at the close position is close to the body casing, and covers the body casing 2B from the front side. More specifically, on the front wall of the body casing 2B, an attachment opening 42 for attachment and detaching is formed, and the cover 51 at the close position covers the attachment opening 42 from the front side.

The cover 51 at the removed position is removed from the body casing 2B as shown in FIG. 1B, and opens the inner structure of the body casing 2B and the attachment opening 42 toward the front side. When the cover 51 is at the removed position, the front end of the process unit 50 attached to the body casing 2B is exposed toward the front side from the front wall of the body casing 2B via the attachment opening 42.

Although in the normal state the cover 51 is at the closed position, it is possible to withdraw the process unit 50 from the front side via the opened attachment opening 42, and to enter the process unit 50 into the inside of the body casing 2B from the front side. That is, when the cover 51 is at the removed position, it is possible to attach the process unit 50 to or detach the process unit 50 from the body casing 2B. In this embodiment, the attaching or detaching direction is the back-and-front direction. For detaching and attaching of the process unit 50, the user grips the handle 55.

The process cartridge 50 includes a frame (a process frame 43) which supports the four process cartridges 13 to be arranged in the back-and-forth direction. The process frame 43 has a form of a rectangular frame to have an inner space 44 at the center position when viewed as a plan view. By inserting the process cartridge 13 into the inner space 44, the process cartridge 13 is supported by the process frame 43. The above described handle 55 is attached to the upper portion of the front wall 43A of the process frame 43.

At the front end of the process frame 43, a reference axis 45 protruding toward the outside in the axial direction is integrally provided. At the rear periphery of the process frame 43, a recess 46 formed to be recessed toward the front side is formed. When the process unit 50 is attached to the body casing 2B, the reference axis is hooked to the body casing 2B, and a reference axis (not shown) of the body casing 2B fits to the recess 46. By this structure, the process unit 50 is positioned at a predetermined position in the state where the process unit 50 is attached to the body casing 2B.

As shown in FIG. 11, the printer 1B is provided with the paper carrying unit 20 configured to carry the sheet of paper 100 supplied from the paper supply cassette 7 to a fixing unit 11. In the following, it is assumed that the process unit 50 is attached to the body casing 2B, and the cover 51 is at the close position unless otherwise stated.

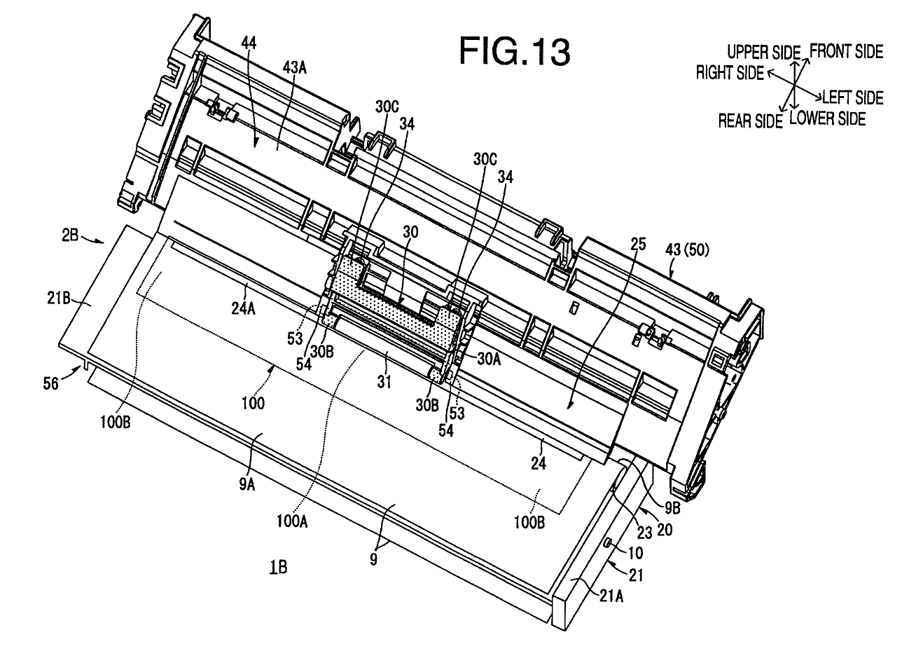

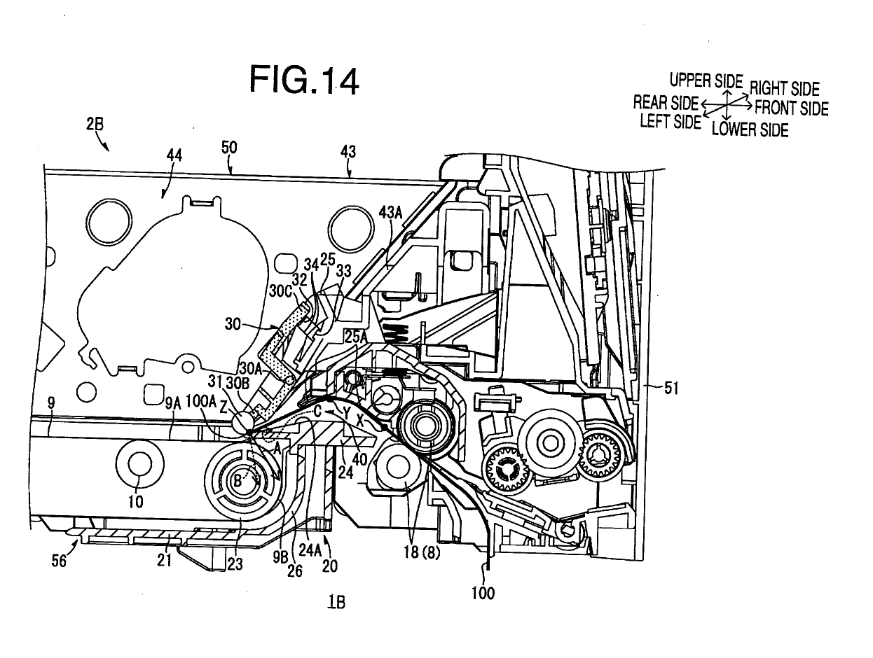

FIG. 13 is a perspective view of a paper carrying unit 20 illustrating a portion around the front wall of the process frame when viewed from a rear left side. FIG. 14 is an enlarged side cross section illustrating a main part of the paper carrying unit 20. In the body casing 2B, the paper carrying unit 20 is located on an upper side of the paper supply cassette 7 and on a lower side of each process cartridge 13. The paper carrying unit 20 has the carrying belt 9 and the transfer roller 10, and further has a frame (a carrying frame 21), a drive roller 22 and a driven roller 23.

As shown in FIG. 13, the carrying frame 21 has a form of a thin rectangular frame when viewed as a plan view. In FIG. 12, only a front side portion of the carrying frame 21 is illustrated. The drive roller 22 and the driven roller 23 are arranged along the back-and-forth direction to have a certain interval. That is, a center axis of each of the drive roller 22 and the driven roller 23 extends in the width direction. More specifically, the drive roller 22 is supported at the rear end of the carrying frame 21, and the driven roller 23 is supported at the front end of the carrying frame 21.

The carrying belt 9 has the width larger than the sheet of paper 100. The carrying belt 9 is an endless belt made of resin such as polycarbonate. The carrying belt 9 is wound around the drive roller 22 and the driven roller 23 to have a certain tension. That is, the carrying belt 9 is supported on the carrying frame 21 via the drive roller 22 and the driven roller 23. In this state, at least the upper surface of the carrying belt 9 (i.e., an upper part 9A which is an example of a carrying surface) is kept to be horizontal (see FIGS. 11 and 13). Each of the left end 21A and right end 21B is formed to protrude in the width direction relative to the side edge of the carrying belt 9 throughout the entire range between the drive roller 22 and the driven roller 23 in the back-and-forth direction.

As described above, four transfer rollers 10 are provided for respective photosensitive drums 3. Each of the transfer rollers 10 is supported on the carrying frame 21. As shown in FIG. 11, the transfer rollers 10 are arranged along the back-and-forth direction. Each of the transfer rollers 10 is provided in the inner portion of the carrying belt 9 wound around the drive roller 22 and the driven roller 23 to face the corresponding photosensitive drum 3 from the lower side via the upper part of the carrying belt 9.

When the image formation is performed, the drive roller 22 is rotated while being applied a driving force from a motor (not shown) provided in the body casing 2B. Accordingly, the carrying belt 9 moves to rotate in the counterclockwise direction when viewed from the left side (see FIG. 11), and the driven roller 23 is driven to rotate. Consequently, the upper part 9A of the carrying belt 9 moves from the front side toward the rear side in the substantially horizontal direction.

When the sheet of paper 100 which has been carried to the carrying belt 9 from the paper supplied cassette 7 is placed on the upper part 9A of the carrying belt 9, the sheet of paper 9 is carried from the front side toward the rear side. Along the carrying path of the sheet of paper 100, the sheet of paper passes a contact position (a transfer position) at which the photosensitive drum 3 contacts the upper part 9A of the carrying belt 9. At this moment, the toner images of the photosensitive drums 3 are transferred sequentially to the sheet of paper 100 to be overlaid with respect to each other. Then, the sheet of paper 100 on which the toner images have been transferred is carried further toward the rear side, and is supplied to the fixing unit 11.

As shown in FIG. 14, the paper carrying unit 20 includes a guide unit having a first guide member 24 and a second guide member 25. The first guide member 24 is a plate-like member having a longer side extending in the width direction (perpendicular to the carrying direction of the sheet of paper 100), and has the width larger than the width of the carrying belt 9. Although not shown in the drawings, the first guide member 24 is supported on the frame 21 by being bridged between the front ends of the left end 21A and the right end 21B of the carrying frame 21. In this state, the first guide member 24 faces a part of the carrying belt 9 where the carrying belt 9 corresponds to the top of the driven roller 23, from the upper side to have a predetermined interval with respect to the carrying belt 9. That is, the first guide member 24 does not contact the carrying belt 9. The upper surface of the first guide member 24 is formed to tilt in the rear and downward direction. This upper surface of the first guide member 24 is defined as a first guide surface 24A. The first guide surface 24A approaches the upper part 9A of the carrying belt 9 from the upper side, from the front side toward the rear side (i.e., toward the downstream side).

A guard 26 is integrally attached to the first guide member 24. The guard 26 is formed to extend downward while bending along a bending part 9B which bends along the outer surface of the driven roller 23 so that the guard 26 faces the bending part 9B from the front side to have a predetermined interval. By this structure, the guard 26 protects the bending part 9B from the front side.

The second guide member 25 is a plate-like member having a longer side extending in the width direction. The second guide member 25 has the same size in the width direction as the first guide member 24. As shown in FIG. 13, the second guide member 25 is a plate-like member having a longer side in the width direction. As shown in FIG. 13, the second guide member 25 is integrally provided on the rear face of the front wall 43A of the process frame 43 of the process unit 50. That is, the second guide member 25 is not provided on the carrying frame 21. The rear face of the front wall 43A faces the inner space 44 of the process frame 43 from the front side. The second guide member 25 forms the lower end of the front wall 43A, and protrudes toward the rear side with respect to the rear face of the front wall 43A.

As shown in FIG. 14, in the state were the process unit 50 is attached to the body casing 2, the second guide member 25 does not contact the carrying belt 9, and faces the first guide member 24 from the upper side to have a predetermined interval. Similarly to the first guide surface 24A, the entire second guide member 25 tilts toward the rear side. More specifically, the tilting angle of the second guide member 25 with respect to the horizontal surface is larger than the tilting angle of the first guide member 24 with respect to the horizontal surface.

The lower surface of the second guide member 25 slanting as described above faces the upper surface (including the first guide surface 24A) of the first guide member 24 from the upper side. The lower surface of the second guide member 25 facing the first guide surface 24A is defined as a second guide surface 25A. The second guide surface 25A is formed to smoothly protrude upward, and then to tilt to ward the rear lower side to approach the first guide surface 24A from the front side toward the rear side.

When viewed from the left side, space 40 sandwiched between the first guide surface 24A and the second guide surface 25A has a triangular shape becoming thinner toward the rear side. The space 40 has the width larger than that of the sheet of paper 100. The rear end of the space 40 faces the upper part 9A of the carrying belt 9 from the front and upper side. The pair of registration rollers 18 are located to face the opened part of the space 40 in the state where the registration rollers 18 face with each other. The registration rollers 18 are supported on the rear face of the cover 51 to be rotatable freely, and form a part of the paper carrying unit 20.

As shown in FIG. 13, under the center portion on the upper surface of the second guide member 25, the support member 30 and the pressing member 31 are provided. The support member 30 is a plate-like member when viewed as a plan view, and has a longer side in the width direction (see a part indicated by dots in FIG. 13). The support member 30 is supported by the second guide member 25 to be rotatable freely in the state where the support member 30 tilts toward the rear lower side along the second guide member 25. As shown in FIG. 14, the rotation center 30A of the support member 30 is located at the substantially center position of the support member 30 in the vertical direction and the back-and-forth direction.

The lower end of the support member 30 is defined as an end 30B, and the upper end of the support member 30 is defined as an end 30C. The rotation center 30A is positioned to be sandwiched by the ends 30B and 30C both in the vertical direction and in the left and right direction. When the support member 30 rotates about the rotation center 30A, the ends 30B and 30C move up and down. More specifically, when the end 30B moves upward, the other end 30C moves downward, and when the end 30B moves downward, the other end 30C moves upward.

As shown in FIG. 13, at both right and left ends of the support member 30 around the end 30B, projections 53 serving as restriction members are integrally formed to protrude outward in the width direction. In other words, each projection 53 is provided on the process frame 43 via the support member 30 and the second guide member 25. As indicated by a dotted line in FIG. 13, projections 53 are located to be inserted under catching parts 54 formed on the second guide member 25 close to the eight and left ends of the end 30B of the support member 30. Therefore, if the end 30B moves upward more than necessary when the support member 30 rotates, each projection 53 is caught by the catching part 54 from the lower side. Therefore, the end 30B is not able to move upward further, and the rotational motion of the support member 30 is stopped. In addition to the state where the process unit 50 is attached to the body casing 2B, the projection 53 serves to restrict the rotational movement of the support member 30 in the clockwise direction when viewed from the left side in the state where the process unit 50 is detached from the body casing 2B.

As shown in FIG. 14, on a lower surface of the end 30C of the support member 30, a boss 32 is integrally formed with the support member 30 to protrude downward. On a part of the second guide member 25 facing the boss 32 from the lower side, a boss 33 is integrally formed with the second guide member 25 to protrude upward. Between the boss 32 and boss 33, a spring 34 serving as a biasing member is inserted. By this structure, the end 30C at which the boss 32 is formed is pressed toward the upper side by the spring 34 producing an elastic force to extend upward. Accordingly, the support member 30 is pressed entirely to rotate in the counterclockwise direction when viewed from the left side. Consequently, the end 30B is pressed downward (specifically, the end 30B is pressed in the downward and front direction as indicated by an arrow A in FIG. 14).

The pressing member 31 is a roller member formed to extend in the width direction and to have a center axis extending in the width direction. The pressing member 31 is rotatably attached to the end 30B of the support member 30. That is, the pressing member 31 is provided on the process unit 50, and is supported by the second guide member 25 via the support member 30. The support member 30 is located to extend from the end 30B at which the pressing member 31 is provided toward the upstream side. That is, the support member 30 extends toward the front side in the upwardly slanting direction.

Since the support member 30 is able to rotate as described above, the pressing member 31 moves up and down in accordance with the rotational motion of the support member 30, and therefore the pressing member 31 is able to approach and move away from the rear end of the first guide surface 24A. In the normal state, the end 30C of the support member 30 is pressed by the spring 34 and therefore the end 30B is pressed downward. Therefore, the pressing member 31 supported at the end 30B is pressed downward toward the rear end of the first guide surface 24A. If no object exists between the pressing member 31 and the first guide surface 24A, the pressing member 31 contacts the rear end of the first guide surface 24A from the upper side.

As described above, rotation of the support member 30 in the clockwise direction when viewed from the left side is restricted by the projection 53 of the support member 30 contacting the catching part 54 of the second guide member 25. Therefore, it is possible to prevent the support member 30 from rotating more than necessary in the clockwise direction, and thereby it becomes possible to prevent the pressing member 31 from being detached from the first guide member 24.

Hereafter, the carrying operation where the sheet of paper 100 is carried from the paper supply cassette 7 to the carrying belt 9 is explained. As described above, the top of the stack of sheets of paper 100 accommodated in the paper supply cassette 7 is supplied by the carrying rollers 19 provided around the front end of the paper supply cassette 7, to the space between the pair of registration roller 18.

Then, the pair of registration roller 18 catch the leading edge of the supplied sheet of paper 100, and send out the sheet of paper 100 toward the carrying belt 9 located on the downstream side in the paper carrying direction while being rotated by predetermined timing. At this moment, the pair of registration rollers 18 send out the sheet of paper 100 while contacting at least the center portion of the sheet of paper 100 in the width direction. In FIG. 14, the leading edge X of the sheet of paper immediately after being sent out from the registration rollers 18 is illustrated.

The sheet of paper 100 sent out from the registration rollers 18 is carried toward the rear side, and enters the space 40 (i.e., space sandwiched by the first guide surface 24A and the second guide surface 25 in the vertical direction) from the front side. After further being carried toward the rear side, the sheet of paper 100 contacts the front end part of the second guide surface 25A. In FIG. 14, the leading edge of the sheet of paper 100 defined at this state is assigned the reference symbol “Y”.

Subsequently, the sheet of paper 100 is carried to the rear lower side along the second guide surface 25A, and reaches the contacting portion where the pressing member 31 contacts the rear end of the first guide surface 24A. In FIG. 14, the leading edge of the sheet of paper 100 defined at this stage is assigned the reference symbol Z. As described above, the second guide member 25 guides, on the second guide surface 25A, the sheet of paper 100 toward the carrying belt 9 located on the downstream side in the paper carrying direction.

The center portion 100A of the sheet of paper 100 coincides with the pressing member 31 in the width direction (see FIG. 13). Therefore, only the center portion 100A of the sheet of paper 100 reaches the contacting part of the pressing member 31 and the rear end part of the first guide surface 24A. Since the sheet of paper 100 is carried to the rear side from the registration roller 18, the rear end of the first guide surface 24A is at the rear end of the first guide member 24 in the paper carrying direction.

When the center portion 100A of the sheet of paper 100 (i.e., the leading edge Z of the sheet of paper 100) reaches the contacting part of the pressing member 31 and the first guide surface 24A, the upstream part of the sheet of paper 100 is caught by the registration roller 18. Therefore, the sheet of paper 100 is further carried toward the rear side by the registration roller 18.

Therefore, the center portion 100A of the leading edge Z of the sheet of paper 100 presses upward the pressing member 31 against the pressing force produced by the spring 34 to move the pressing member 31 away from the rear end part of the first guide surface 24A, and thereby the sheet of paper 100 proceeds toward the rear side while passing through the space formed between the pressing member 31 and the first guide surface 24A. Therefore, the entire leading edge Z of the sheet of paper 100 passes the pressing member 31 toward the rear side. That is, the entire sheet of paper 100 is carried toward the rear side subsequently.

When the sheet of paper 100 passes the pressing member 31, only the center portion 100A of the sheet of paper 100 is pressed by the pressing member 31 toward the first guide surface 24A from the upper side, and is pressed against the first guide surface 24A. In this case, the part of the sheet of paper 100 other than the center portion 100A also approaches the first guide surface 24A although the part of the sheet of paper 100 other than the center portion 100A is not pressed against the first guide surface 24A. As described above, the first guide surface 24A tilts such that the first guide surface 24 approaches, from upper side, the upper part 9A of the carrying belt 9 toward the rear side. Therefore, the sheet of paper 100 being carried toward the rear side while approaching the first guide surface 24A is guided to the upper part 9A of the carrying melt 9 along the first guide surface 24A. Thus, the first guide member 24 serves to guide the sheet of paper 100 to the carrying belt 9 located on the downstream side on the first guide surface 24A. Since the pressing member 31 is rotatable, the pressing member 31 presses the center portion 100A of the sheet of paper 100 while rotating in accordance with the movement of the sheet of paper 100, by contacting the upper face of the center portion 100A of the sheet of paper 100 passing between the pressing member 31 and the rear end part of the first guide surface 24A.

As described above, the sheet of paper 100 guided to the upper part 9A of the carrying belt 9 is placed on the upper part 9A and is carried to the transfer position. As described above, the sheet of paper 100 supplied from the paper feed cassette 7 passes the registration rollers 18, the second guide member 25, the pressing member 31, and the first guide member 24 in this order from the upstream side in the paper carrying direction, and then is supplied to the carrying belt 9. It is understood that the pressing member 31 and the first guide member 24 are located on the upstream side with respect to the carrying belt 9 in the paper carrying direction, and the registration rollers 18 are located on the upstream side with respect to the pressing member 31 in the paper carrying direction.

As shown in FIG. 11, in the paper carrying unit 20, the carrying belt 9, the transfer roller 10, the carrying frame 21, the drive roller 22, the driven roller 23 and the first guide member 24 are provided on the body casing 2. On the other hand, the registration rollers 18 is provided on the cover 51, and the second guide member 24, the supporting member 30 and the pressing member 31 are provided on the process unit 50 (i.e., the process frame 43).

The carrying belt 9, the transfer roller 10, the carrying frame 21, the drive roller 22, the driven roller 23 and the first guide member 24 are integrated as a unit (i.e., a belt unit 56). Similarly to the process unit 50, the belt unit 56 is detachably attachable to the body casing 2B from the front side by moving the cover 51 to the removed position (see FIG. 13). By moving the process unit 50 in the state where the lower end portion of each of the second guide member 25, the support member 30 and the pressing member 31 is moved upward from the first guide member 24, the process unit 50 can be attached to or detached from the body casing 2B without interfering with the belt unit 56.

Hereafter, advantages achieved by the printer 2B according to the second embodiment are described.

(1) As described above, the process unit 50 holding the photosensitive drum 3 can be detachably attachable to the body casing 2B. As shown in FIG. 14, in the body casing 2B, the carrying belt 90 which carries the sheet of paper 100, and the first guide member 24 located on the upstream side of the carrying belt 9 in the paper carrying direction are provided. In the process unit 50, the pressing member 31 located on the upstream side of the carrying belt 9 in the paper carrying direction is provided.

Since the pressing member 31 presses only the center portion 100A of the sheet of paper defined in the width direction, the center portion 100A is pressed against the first guide member 24 located to face the pressing member 31.

Therefore, on the sheet of paper 100 being carried toward the carrying belt 9, resistance acts only on the center portion 100A. Such a configuration makes it possible to prevent the center portion 100A from being carried ahead of the other part (i.e., the both ends 100B) of the sheet of paper 100. That is, preceding of the center portion of the sheet of paper can be prevented.

Since the process unit 50 holds the photosensitive drum 3, the process unit 50 can be precisely positioned with respect to the body casing 2B via the reference axis 45 and the recess 46. Accordingly, the pressing member 31 provided on the process unit 50 can also be positioned relatively precisely. Therefore, the pressing member 31 is able to precisely press only the center portion 100A of the sheet of paper 100.

As shown in FIG. 14, if the pressing member 31 presses at least the leading edge (i.e., the leading edge Z) on the center portion 100A of the sheet of paper 100, not only preceding of the leading edge Z but also the preceding of the upstream region defined from the leading edge Z on the sheet of paper 100 is also prevented. Consequently, it becomes possible to prevent the preceding of the central portion over the entire paper carrying direction on the sheet of paper 100.

If the center portion of the sheet of paper moves to precede the both ends of the sheet of paper 100, a force pointing from the each of the both ends 100B to the center portion 100A acts in the width direction. However, in this case, a force pointing from the center portion 100A to each of the both ends 100B acts on the sheet of paper 100 because the pressing member 31 presses only the center portion 100A. Consequently, the forces acting in the width direction are canceled with each other.

(2) As shown in FIG. 13, the pressing member 31 is able to rotate by contacting the sheet of paper 100 being carried without receiving a driving force from a motor. Therefore, by rotating on the sheet of paper 100 while pressing the sheet of paper 100, the pressing member 31 does not cause friction more than necessary on the sheet of paper 100. Therefore, it is possible to smoothly carry the sheet of paper 100 to the carrying belt 9 while preventing the preceding of the center portion.

(3) As shown in FIG. 14, the pressing member 31 is able to approach or move away from the first guide member 24. Therefore, the pressing member 31 is able to press the center portion 100A of the sheet of paper 100 with an appropriate force not causing resistance more than necessary on the sheet of paper 100.

It should be noted that the pressing member 31 does not contact the carrying belt 9. Therefore, the carrying belt 9 is not worn by the pressing member 31.

(4) The pressing member 31 is able to contact the downstream end part of the first guide member 24 defined in the paper carrying direction (i.e., the rear end of the first guide surface 24A closest to the carrying belt 9).

Therefore, it is possible to prevent the preceding of the center portion of the sheet of paper 100 at a position immediately before the carrying belt 9. Therefore, the preceding of the center portion does not occur on the sheet of paper 100 being carried toward the carrying belt 9 after passing the pressing member 31. Consequently, the sheet of paper 100 is carried in the state where the preceding of the center portion is prevented, and is supplied to the carrying belt 9 while keeping the state where the preceding of the center portion is prevented.

That is, by preventing the preceding of the center portion of the sheet of paper 100 at the position immediately before the carrying belt 9, it is possible to effectively prevent the sheet of paper 100 from being carried to the carrying belt 9 in the state where the preceding of the center portion occurs.

(5) The rear end part of the first guide surface 24A configured to contact the pressing member 31 is formed as a tilting surface to approach the carrying belt 9 toward the downstream side in the paper carrying direction. By this structure, the sheet of paper 100 proceeding toward the carrying belt 9 after passing the pressing member 31 can be smoothly supplied to the carrying belt 9 while being guided by the first guide surface 24A. Consequently, it is possible to achieve the smooth carrying of the sheet of paper 100.

(6) As shown in FIG. 14, in the process unit 50, the second guide member 25 which is positioned to face the first guide member 24 and guides the sheet of paper 100 to the carrying belt 9 is provided. Therefore, the sheet of paper 100 is guided by the second guide member 25 as well as the first guide member 24. Consequently, the sheet of paper 100 is guided smoothly to the carrying belt 9.

Since the pressing member 31 is supported by the second guide member 25, the second guide member 25 serves as a member for guiding the sheet of paper and as a member for supporting the pressing member 31. Therefore, the number of components can be reduced.

By contrast, if the second guide member 25 does not support the pressing member 31, it becomes necessary to provide a metal axis extending in the width direction at the front wall 43A of the process frame 43 and to support the pressing member 31 with the metal axis. In this case, cost increases in comparison with the case where the pressing member 31 is supported on the second guide member 25.

(7) Since the support member 30 which is rotatably provided while supporting the pressing member 31 is provided on the second guide member 25, the pressing member 31 is able to approach and move away from the first guide member 24 by rotating together with the support member 30.

(8) The support member 30 having the rotation center 30A positioned to be sandwiched by the end 30B and the end 30C supports the pressing member 31 at the end 30B. The end 30C is pressed by the spring 34 such that the pressing member 31 is pressed toward the first guide member 24. Therefore, the pressing member 31 is able to approach the first guide member 24 by being pressed by the spring 34. That is, it is possible to strongly press the center portion 100A of the sheet of paper 100.

(9) The support member 30 is positioned such that the end 30B is situated on the downstream side with respect to the end 30C in the paper carrying direction, and that the support member 30 tilts toward the downward and rear side so that the end 30B approaches the sheet of paper 100 toward the downstream side in the paper carrying direction.

By this structure, if the pressing member 31 provided at the end 30B moves down and approaches the first guide surface 24A while the end 30C is pressed by the spring 34, the pressing member 31 is able to apply a part (i.e., a component force C illustrated by a dotted line in FIG. 14) of the pressing force of the spring 34 (i.e., the pressing force A illustrated in FIG. 14 to point to the downward and upstream direction) to the sheet of paper 100 as a force pointing to the upstream side while pressing the center portion 100A of the sheet of paper 100 passing between the pressing member 31 and the first guide surface 24. In FIG. 14, another component force C perpendicularly acting with respect to the component force B is also illustrated in FIG. 14. Consequently, the resistance is produced only in the center portion 100A of the sheet of paper 100. It becomes possible to securely prevent occurrence of the preceding of the center portion of the sheet of paper 100.

Since the support member 30 is tilted, the pressing member 31 is able to move away from the first guide member 24 by the reactive force from the sheet of paper 100 while pressing the sheet of paper 100. Therefore, the sheet of paper 100 is able to smoothly pass between the pressing member 31 and the first guide member 24.

By contrast, when the end 30C is located on the downstream side with respect to the end 30B in the paper carrying direction, and the support member 30 is formed to tilt in the downward and front direction toward the end 30B so that the end 30B side of the support member 30 approaches the sheet of paper 100 toward the upstream direction, the pressing member 31 is not able to press the sheet of paper 100. Rather, in this case, the pressing member 31 is pressed toward the first guide member 24, and blocks the space between the pressing member 31 and the first guide member 24. In this case, the sheet of paper 100 is not able to pass between the first guide member 24 and the pressing member 31, and therefore paper gamming will occur.

(10) As shown in FIG. 13, the process unit 50 is provided with the projection 53 serving to limit the rotation motion of the support member 30 when the process unit 50 is detached from the body casing 2B. Therefore, it becomes possible to prevent the support member 30 from rotate unnecessarily when the process unit 50 is detached from the body casing 2B.

(11) The registration roller 18 located on the upstream side in the paper carrying direction contact al least the center portion 100A of the sheet of paper 100 to send out the sheet of paper 100 toward the pressing member 31 located on the downstream side in the paper carrying direction at predetermined timing. In this case, the center portion 100A is inevitably prone to be carried easily in comparison with the both ends 100B in the width direction. Therefore, the preceding of the center portion of the sheet of paper may occur on the sheet of paper 100 immediately after passing through the registration rollers 18. However, thanks to the pressing member 31, the occurrence of the preceding of the center portion of the sheet of paper can be prevented.

(Variations)

Hereafter, variations of the above described second embodiment are explained.

In the above described embodiment, the pressing member 31 provided at the end 30B is pressed toward the sheet of paper with the spring 34. However, an elastic film member may be used in place of the spring 34 and the pressing member 31. In this case, the film is attached to the process frame 43 (i.e., the second guide member 25) in the state of being deformed. When the film restores to an original shape, the tip of the film serves as the pressing member 31 to press the center portion of the sheet of paper 100.

In the above described second embodiment, the printer is configured to form a electrostatic latent image by exposing the photosensitive drum 3 with a laser beam. However, the feature of the above described second embodiment may be applied to various types of image forming devices, such as a printer configured to expose the photosensitive drum 3 with an LED. The feature of the second embodiment may also be applied to various types of image forming devices configured to carry a sheet of paper with a carrying belt.

What is claimed is:

1. A recoding medium carrying device, comprising:
a carrying unit configured to carry a recording medium in a carrying direction which is substantially perpendicular to a width direction of the recording medium;
a guide member that is provided on an upstream side of the carrying unit in the carrying direction and has a guide surface located to face a surface of the recording medium to guide the recording medium along the guide surface; and
a resistance member that is located on the guide member and applies stronger resistance to a center portion of the recording medium in the width direction in comparison with both ends of the recording medium in the width direction.

2. The recoding medium carrying device according to claim 1, wherein the resistance member comprises a pressing member that is positioned to face the guide surface and presses the recording medium against the guide surface.

3. The recoding medium carrying device according to claim 2, wherein the pressing member comprises a roller that is rotatable in accordance with carrying of the recording medium by contacting the recording medium being carried.

4. The recoding medium carrying device according to claim 2, wherein the pressing member is located to be able to approach or move away from the guide surface and is applied a pressing force to be pressed toward the guide surface.

5. The recoding medium carrying device according to claim 4, further comprising a switch member configured to switch the pressing force acting to press the pressing member toward the guide surface.

6. The recoding medium carrying device according to claim 5,
wherein the switch member comprises:
a sliding member which is provided at a central portion of the guide member in the width direction and is configured to be able to slide between a first position and a second position defined along the width direction;
a biasing member which presses the pressing member toward the guide surface; and
an adjustment member configured to let the biasing member press the pressing member when the sliding member is at the first position and release a pressed state of the pressing member by the biasing member when the sliding member is at the second position.

7. The recoding medium carrying device according to claim 4, wherein the pressing member is located to be able to contact a downstream end part of the guide surface defined in the carrying direction.

8. The recoding medium carrying device according to claim 1, wherein the guide surface includes a slanting surface formed to approach the carrying unit toward a downstream side in the carrying direction.

9. The recoding medium carrying device according to claim 1,
wherein the guide surface includes:
a first guide surface facing one of surfaces of the recording medium; and
a second guide surface facing the other of the surfaces of the recording medium,
wherein space formed between the first guide surface and the second guide surface becomes wider toward an upstream side in the carrying direction.

10. The recoding medium carrying device according to claim 9,
wherein:
the resistance member is located to face one of the first and second guide surfaces; and
the resistance member comprises a pressing member which presses the recording medium against the one of the first and second guide surfaces.

11. The recoding medium carrying device according to claim 10,
wherein:
the other of the first and second guide surfaces has a support member provided with the pressing member at an end of the support member; and
the support member is provided to be able to rotate so that the pressing member is able to move in a direction substantially perpendicular to the other of the first and second guide surfaces.

12. The recoding medium carrying device according to claim 11,
wherein:
the support member is formed to extend toward an upstream side in the carrying direction from the end at which the pressing member is provided; and
the support member forms at least a part of the other of the first and second guide surfaces.

13. The recoding medium carrying device according to claim 1, further comprising a frame on which the carrying unit and the guide member are provided.

14. The recoding medium carrying device according to claim 1,
wherein:
the carrying unit comprises a belt having a carrying surface on which the recording medium is placed; and
the guide member has a tilting surface formed to approach the carrying surface toward a downstream side in the carrying direction to guide the recording medium along the tilting surface.

15. An image forming device, comprising:
a recording medium carrying device according claim 1; and
an image formation unit configured to form an image on a recording medium being carried by the recording medium carrying device.

16. The image forming device according to claim 15,
further comprising a registration roller which is located on an upstream side with respect to the resistance member in the carrying direction and sends the recording medium at predetermined timing toward a downstream side in the carrying direction while contacting at least a center portion of the recording medium in the width direction of the recording medium.

17. An image forming device, comprising:
a main body;
a photosensitive unit having a photosensitive body on which an electrostatic latent image is formed, the photosensitive unit being formed to detachably attachable to the main body;
a carrying unit provided in the main body to carry a recording medium in a carrying direction;
a pressing member which is provided in the photosensitive unit and is located on an upstream side in the carrying direction with respect to the carrying unit, the pressing member being provided to press only a center portion of the recording medium defined in a width direction which is substantially perpendicular to the carrying direction; and
a first guide member which is provided in the main body and is located on the upstream side in the carrying direction with respect to the carrying unit, the first guide member guiding the recording medium toward the carrying unit.

18. The image forming device according to claim 17, wherein the pressing member comprises a roller which is rotatable by contacting the recording medium being carried.

19. The image forming device according to claim 17, wherein the pressing member is located to be able to approach or move away from the first guide member.

20. The image forming device according to claim 19, wherein the pressing member is located to be able to contact a downstream end part of the first guide member in the carrying direction.
